(19) United States
(12) Patent Application Publication
(10) Pub. No.: US 2026/0228422 A1
(43) Pub. Date: Aug. 6, 2026

(54) SYSTEM AND METHOD FOR DYNAMICALLY GENERATING TRAINING DATA

(71) Applicant: Mirata Software, LLC, Chicago, IL (US)

(72) Inventors: Richard W. Padula, Chicago, IL (US); Randall Fredrick, Steamboat Springs, CO (US); Ronald Erickson, Sleep Hollow, IL (US); Paul Wisdom, Woodridge, IL (US)

(21) Appl. No.: 19/046,849

(22) Filed: Feb. 6, 2025

(51) Int. Cl. G06F 40/174; G06F 16/22; G06N 20/00

(52) U.S. Cl. CPC G06F 40/174; G06F 16/2228; G06N 20/00

(57) ABSTRACT

A computer-implemented method, computer program product, and computer system for defining and using a declarative definition language to generate training data. In some embodiments, the computer-implemented method includes rendering a form that includes one or more sections defined by a declarative definition language. In response to receiving input for a completed section of the one or more sections of the rendered form, disclosed embodiments generate a data structure that memorializes user interactions within the completed section of the rendered form.

### CROSS-REFERENCE TO RELATED APPLICATION

The field of the invention relates generally to methods and systems of dynamically defining and generating forms and workflows based on a user's input, This Patent Application is related to U.S. patent application Ser. No. 17/241,633 entitled A System and Method For Dynamically Defining Digital Forms (now issued U.S. Pat. No. 11,423,210). The disclosure of the prior Application is considered part of and is incorporated by reference, in its entirety into this Patent Application.

### FIELD OF THE INVENTION

The field of the invention relates generally to methods and systems for creating training data sets for large language process models during form generation.

### BACKGROUND

Today, most data in field force industries (e.g., field sales, field services, inspection and reporting, etc.) is distributed and captured on paper-based forms which are then physically routed among various stakeholders both in offices and fields, with updates to back-end systems being a manual process. There is a significant business benefit to digitizing these forms, automatically electronically routing these forms the stakeholders, and automatically updating the back-end systems. There have been many attempts to develop such forms, however, current approaches are limited in terms of what can be done before resorting to manual and complex coding. Current approaches are also designed based on the technical features of a browser (e.g., a web browser) rather than the needs of a user. These approaches use a combination of an extensible-mark-up-language, such as hypertext markup language (HTML), and a style sheet language, such as cascading style sheets (CSS), and when complex logics are involved, one must code these complex logics in JavaScript, requiring additional skills and thereby limiting who can create and design forms.

For example, conventional approaches are described in U.S. Pat. Nos. 9,836,446, 10,394,948, and 10,585,982, which describe systems and methods for customizing mobile-form applications for distribution to mobile devices. These references describe utilization of an extensible markup language (XML) schema for use with digital forms that is well-known and conventional in the art, but which is limited and inflexible. In particular, these references describe using XForms—which utilizes XPath for calculations—for the generation of digital forms. Unfortunately, XForms are not designed for use with data forms, and moreover, the data forms disclosed in these references do not feature a specialized calculations engine and have no support for dynamic styling. These conventional approaches also do not provide for fine-tuned control over the layout of a form aside from basic grouping of controls. Instead of relying on a browser to figure out the layout of a form using a combination of HTML and CSS, there is a need for a richer set of features for layout control, including column and row sections, field height and width, margins, and other dynamic features like tabs and collapsible areas. While XForms works with XML-based data, most modern web APls use JSON because it is more compact, easier to parse, and just as capable at payload delivery. Thus, the XForms design severely limits its adaptability. There is thus a need to work across a variety of formatting, including JSON and XML, and to provide significant flexibility to form designers to permit the creation of dynamic forms as further described herein.

Therefore, it would be desirable to have a system and method for designing, routing, filling out, and recording of digital forms across multiple computing platforms with an ability to use data of those forms to update back-end systems—that allows forms made by those who are not skilled at coding to nonetheless be able to design forms with sophisticated logic designed specifically to individual needs. It is further desirable to dramatically expand the number of users who can design complex, enterprise-grade digital forms and work-flow for complex processes, thus lowering costs and accelerating adoption.

A large process model (LPM) is envisioned as a neuro-symbolic software system that integrates process management knowledge accumulated by experts and precise data on how organizations run their processes. Given process data in an event log or relational format, the LPM automatically identifies the domain of a specific process as well as the context of the organization that runs it, to then generate insights and action recommendations, using a collection of tools for process design, analysis, execution, and prediction. As organizational context, process data alone is sufficient, but additional information, e.g., in the form of process models or unstructured documents, can be automatically ingested in order to augment context-specific LPM capabilities. LPM knowledge is partially encoded in an large language model (LLM) and partially managed as symbolic process atoms, which are models and query templates generated by an ensemble of deep learning techniques and special-purpose algorithms.

Systems and methods that allowed for designing, routing, filling out, and recording of digital forms across multiple computing platforms that allow forms made by those who are not skilled at coding are known in, for example, U.S. Pat. No. 11,423,210. However, those systems and methods lacked solutions to integrate and manipulate collected data with large process models and how to use such large process models as part of enhanced training data.

Typical models and rules bases needed for executing corresponding checks and integrating them into operations are cumbersome and maintenance of those models is resource intensive. Symbolic models and rules are, even if correct from a logical perspective (i.e., object-level), are prone to be dated, inconsistent, or incorrectly modeled from a domain perspective. Other traditional data sources may only present results of the process and provide little to no information regarding the process undergone to yield results of the process.

Typical solutions of process mining use event logs that have been extracted from enterprise systems as input data. These event logs are typically not readily available and generating them as a result of Extract-Transform-Load (ETL) pipelines is known to incur substantial efforts. Even when event logs are generated, they only contain a small subset of the process data that exists in an organization, because not all relevant information technology systems can be accessed or because substantial parts of the process are executed through informal channels (and are hence not recorded in database tables). The resultant data collected is therefore incomplete, inaccurate, and lacks contextual data that govern processes.

Therefore, it would be desirable to have a system and method for generating training data that improves process observability and accuracy of an LPM by reducing effort and expertise required for knowledge based process management tasks. By improving process observability, accuracy, and reducing the effort and expertise to generated data, the resultant system and method can recommend changes to process models and scale generic insights derived from process data across organizations by automatically generating templates from commonly executed queries and instantiating them automatically in a given context.

### SUMMARY

Embodiments of the present invention provide a computer-implemented method for using a declarative definition language to generate training data. In some embodiments, the computer-implemented method includes rendering a form that includes one or more sections defined by a declarative definition language. In response to receiving input for a completed section of the one or more sections of the rendered form, embodiments of the present invention generate a data structure that memorializes user interactions within the completed section of the rendered form.

Embodiments of the present invention further provide a computer program product for using a declarative definition language to generate training data. In this embodiment, a computer program product includes one or more processors and one or more computer readable storage media that when executed by the one or more processors, cause program instructions stored on the one or more computer readable storage media to render a form that includes one or more sections defined by a declarative definition language. In response to receiving input for a completed section of the one or more sections of the rendered form, embodiments of the present invention generate a data structure that memorializes user interactions within the completed section of the rendered form.

Embodiments of the present invention further provide a computer system for using a declarative definition language to generate training data. In this embodiment, a computer system includes one or more processors, one or more computer readable storage media, and program instructions stored on the one or more computer readable storage media that when executed by the one or more processors, cause the program instructions to render a form that includes one or more sections defined by a declarative definition language. In response to receiving input for a completed section of the one or more sections of the rendered form, embodiments of the present invention generate a data structure that memorializes user interactions within the completed section of the rendered form.

### BRIEF DESCRIPTION OF THE DRAWINGS

The above and/or other aspects of the invention will be more apparent by describing in detail exemplary embodiments of the invention with reference to the accompanying drawings, in which:

FIG. 1A illustrates a diagram of a system according to an embodiment of the present invention, whereby a computing device can access a digital form on a server through a network.

FIG. 1B provides a diagram of the various modules of one embodiment of the present invention.

FIG. 1C provides a diagram of a system for using a declarative definition language to drive a presentation renderer to render a form.

FIG. 2 provides a diagram of the declarative definition language to support defining a form according to an embodiment of the present invention.

FIG. 3 provides a diagram of the loading process for the declarative definition language according to an embodiment of the present invention.

FIG. 4 provides a diagram of the calculation engine according to an embodiment of the present invention.

FIG. 5 provides a diagram of the presentation renderer according to an embodiment of the present invention.

FIG. 6 provides a diagram of the declarative definition language to support defining a workflow according to an embodiment of the present invention.

FIG. 7 provides a diagram of a designer tool for designing a workflow according to an embodiment of the present invention.

FIG. 8 provides a diagram of a forms repository according to an embodiment of the present invention.

FIG. 9 provides a diagram of a calculations learning engine according to an embodiment of the present invention.

FIG. 10A shows a first page of an exemplary paper form that can be designed and generated into a digital format according to an embodiment of the present invention.

FIG. 10B shows a second page of an exemplary paper form that can be designed and generated into a digital format according to an embodiment of the present invention.

FIG. 11A shows a first example of a digital form generated according to an embodiment of the present invention from the paper form in FIGS. 10A and 10B.

FIG. 11B shows a second example of a digital form generated according to an embodiment of the present invention from the paper form in FIGS. 10A and 10B.

FIG. 11C provides a third example of a digital form generated by the system according to an embodiment of the present invention from the paper form in FIGS. 10A and 10B.

FIG. 11D provides a fourth example of a digital form generated by the system according to an embodiment of the present invention from the paper form in FIGS. 10A and 10B.

FIG. 11E shows a fifth example of a digital form generated according to an embodiment of the present invention from the paper form in FIGS. 10A and 10B.

FIG. 12 represents an exemplary workflow of a created digital form according to an embodiment of the present invention.

FIG. 13 represents an example submission for a generated water leak form, in accordance with an embodiment of the present invention.

FIG. 14 represents an example submission for a generated water leak form in progress, in accordance with an embodiment of the present invention.

FIG. 15 represents an example submission for a completed water leak form, in accordance with an embodiment of the present invention.

### DETAILED DESCRIPTION

This present invention relates to systems and methods for dynamically generating training data during generation of forms using a declarative definition language and rendering the forms to a user. Embodiments of the present invention recognize that one of the challenges in training generative artificial intelligence algorithms stems from incomplete, error prone, or outdated data. In an example case, organizations typically employ domain specific algorithms to ensure regulatory compliance.

Recognizing that challenges in process modeling and training requires improvements to process observability, embodiments of the present invention provide solutions for training generative artificial intelligence algorithms by leveraging declarative definition language presented in created forms to generate sets of training data structured in a manner that documents data created at each state of a process which improves process observability and can be used to retrain large process models. In this manner, embodiments of the present invention improve process observability by creating a data structure to generate training data in a structured manner that that documents data created at each state of a process. For example, as a created form is used (i.e., where information inputted creates form data), embodiments of the present invention create a data structure for each completed section of the form. This created data structure captures a slice in time of the form data and process workflow data, specifically the current data on the form, its current process step in a given workflow, its status, its current assignment, which backend system updates were performed and whether they were successful. In this manner, embodiments of the present invention create more robust training data that yields insights in the captured data and leverage those training data to train one or more large language process models to generate one or more recommendations and subsequently implement those one or more recommendations.

It will be appreciated by those having skill in the art that the implementations described herein may be practiced without these specific details or with an equivalent arrangement. In other instances, well-known structures and devices are shown in block diagram form in order to avoid unnecessarily obscuring the implementations of the invention.

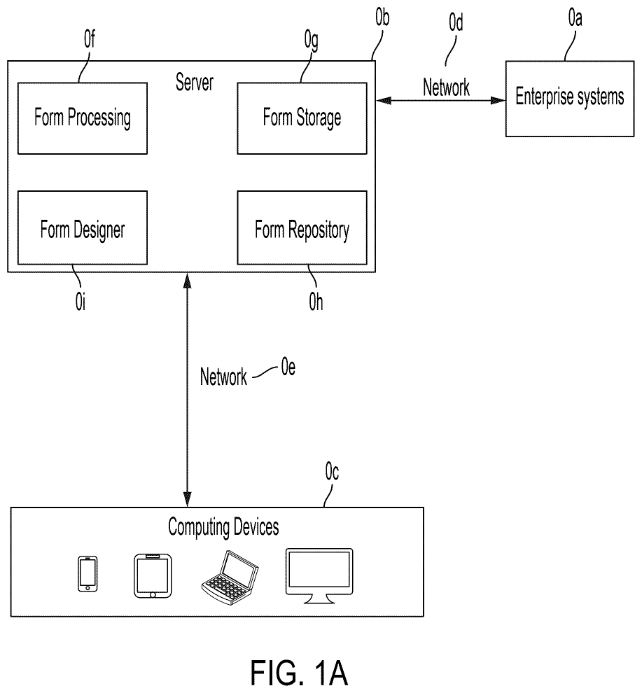

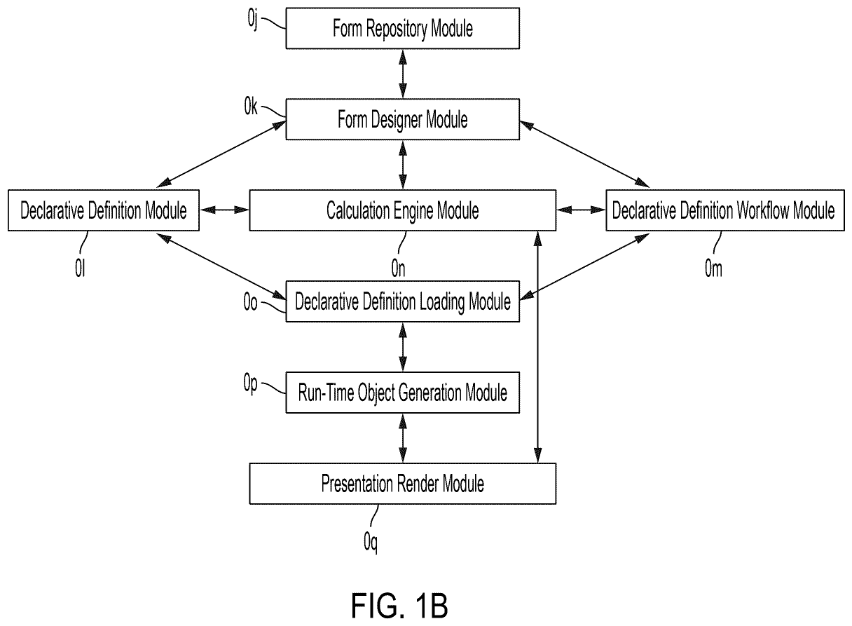

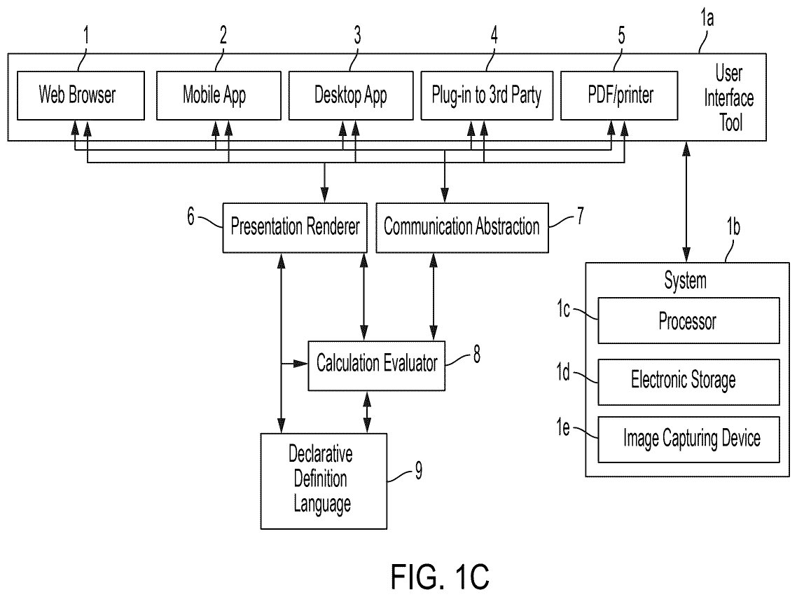

FIG. 1A illustrates a diagram of a system according to an embodiment of the present invention, whereby a computing device can access a digital form on a server through a network.

According to an embodiment of the present invention, enterprise systems 0a are connected via a network 0d to a server 0b. It can be appreciated that this network 0d may be any manner of wired or wireless connection known in the art, including over the Internet. Moreover, the server 0b is also connected over a network 0e to computing devices 0c containing an application, software, program, or other processing devices for implementing the system and method of the present invention. In some embodiments, the network 0d and the network 0e are the same network, and the enterprise systems 0a may be a part of or a component within the server 0b.

The server 0b contains four separate components: a form processing module 0f, a form storage device 0g, a form designer module 0i, and a form repository 0h. The form processing 0f component refers to the one or more devices that execute some or all of the processing necessary for operation of the present invention, including, but not limited to, operations for loading the declarative definition language, updating the back-end systems, and artificial intelligence or machine learning processing. The form storage device 0b component refers to the one or more devices for storing processing instructions, the declarative definition language, and the form data for use with the present invention. The form designer module 0i component is for designing a form and/or workflow such that a person designing a form does not need to know any underlying programming language, allowing a person to preview and edit a WYSIWYG version of a form. Finally, the form repository 0h is a cloud-based or on-premises repository that stores all of the data and definitions for use by the present system and method.

FIG. 1B provides a diagram of the various modules of one embodiment of the present invention.

Further in accord with an embodiment of the present invention, Form Repository Module 0j contains all of the data and definitions for use by the system and method and is a cloud-based or on-premises repository that exposes a REST-ful API to allow access. The Form Repository Module 0j is connected to the Form Designer Module 0k, which uses the REST-ful API to access the Form Repository Module 0j. All calls to the Form Repository Module 0j pass through user authentication and authorization. The Form Repository Module 0j also controls which forms are assigned to which users, and therefore, which forms a user will see and are expected to work on. The Form Repository Module 0j may assign forms to zero, one, or more individual users, as well as to zero, one, or more user groups. Supervisor users may be given access to forms assigned to the workers that they supervise for viewing or for editing. The Form Repository Module 0j also contains definition-related items with the expectation that they will be read frequently but written less often.

A Form Designer Module 0k is connected to the Form Repository Module 0j, the Declarative Definition Module 0l, the Declarative Definition Workflow Module 0m, and the Calculation Engine Module 0n, and uses a REST-ful API in order to access the Form Repository Module 0j. The Form Designer Module 0j is made user-friendly for a person familiar with operations and processes of her business to create forms because a person designing a form does not need to know any underlying programming language. The Form Designer Module 0k provides a form editor, which presents a what-you-see-is-what-you-get view of the form. The user can add and remove fields, and change their attributes. In some embodiments, the Form Designer Module 0k also provides a graphical workflow editor that presents workflows as either a flow chart or a “swim-lane” style process so that the workflows are easy to understand and change. The Form Designer Module 0k may also allow the user to see the form as it would appear on various screen sizes, to enter test data to ensure correct functionality, and to exercise the workflow.

The Declarative Definition Module 0l is connected to the Form Designer Module 0k, the Calculation Engine Module 0n, and the Declarative Definition Loading Module 0o, and defines fields (i.e., data fields) associated with the form and defines how the fields are to be displayed on screens of various computing devices. For example, the Declarative Definition Module 0l includes instructions to display the fields associated with the form on a screen of a mobile device or a screen of a computer. As the form is loaded on a computing device (e.g., a smartphone, tablet, laptop, or desktop), run-time objects are created and populated with instance-specific data. In some embodiments, the form includes calculations and conditional logic, such as automatic population of fields, controlling visibility and appearance of fields, enabling and disabling fields, etc. The Declarative Definition Module 0l defines a data structure for a form based on fields and presentation associated with the form. Such data structure allows data associated with the fields and appearance of the form to the user to be handled separately, thereby enabling the form to be rendered to different screen sizes and capabilities, paper sizes, formats, etc., without requiring rules or code to be written. The Declarative Definition Module 0l is flexible to be used with a variety of data formats, including JSON and XML.

The Declarative Definition Workflow Module 0m is connected to the Form Designer Module 0k, the Calculation Engine Module 0n, and the Declarative Definition Loading Module 0o, and is made user-friendly for a person familiar with operations and processes of her business to create workflows. The person designing the workflow does not need to know any underlying programming language. The Declarative Definition Workflow Module 0m presents workflows as either a flow chart or a “swim-lane” style process so that the workflows are easy to understand and change.

The Calculation Engine Module 0n is connected to the Form Designer Module 0k, the Declarative Definition Module 0 l, and the Declarative Definition Workflow Module 0m. In some embodiments, the Calculation Engine Module 0n assists the user when working with calculations and has a learning feature that recognizes common patterns of usage and suggests them. The learning feature uses machine learning to identify common patterns across all of the fields on all of the forms in the system and suggest the appropriate calculations or calculation arguments within the context of the field. The machine learning aspect allows the Calculation Engine Module 0n to evolve over time as more calculations are entered or updated and more forms are added to the system. Thus, the learning feature results in faster and more efficient operation and enhances the form designer's experience.

In some embodiments, the Declaration Definition Loading Module 0o is connected to the Declarative Definition Module 0l and downloads or loads data from the Declarative Definition Module 0l from a server, local or networked storage, local cache, loaded from a local database, loaded from a remote database, or loaded from any other storage system or architecture known in the art. In an exemplary embodiment of the present invention, JSON is used as an underlying text-based representation in the stored language text but it can be appreciated that other formats could be used, such as YAML, XML, binary representation custom/proprietary formats, etc. In some embodiments, the stored language text is initially parsed from JSON (or other) into a basic keys-and-values nested dictionary structure. The keys-and-values nested dictionary structure is then validated against a schema to ensure that a JSON data structure matches an expected structure, and if so, results in validated structures. Once the JSON data structures are validated, the Run-Time Object Generation Module 0p creates run-time objects and methods such that they can then be used directly by other components of the system, such as the Presentation Renderer Module 0p and the Calculation Engine Module 0n.

The Presentation Renderer Module 0q translates the instructions of the Declarative Definition Module 0l, including any calculations from the Calculation Engine Module 0n, into instructions that a user interface tool uses, such as HTML for a web browser. The Presentation Renderer Module 0q makes it so that the form can be displayed in a web browser, a mobile app, a desktop app, a plug-in installed into a third-party application (thus adding the form capability to a third-party system), or to a printed page. It can be appreciated that the printed page can be in any form of physical or digital printing, including printing in Adobe PDF format.

FIG. 1C provides a diagram of a system for using a declarative definition language to drive a presentation renderer to render a form.

In a first embodiment of the present invention, a form is defined based on a declarative definition language 9. The declarative definition language 9 defines fields (i.e., data fields) associated with the form and defines how the fields are to be displayed on screens of various computing devices. For example, the declarative definition language 9 includes instructions to display the fields associated with the form on a screen of a mobile device or a screen of a computer. As the form is loaded on a computing device, run-time objects are created and populated with instance-specific data. In some embodiments, the form includes calculations 8 and conditional logic, such as automatic population of fields, controlling visibility and appearance of fields, enabling and disabling fields, etc.

According to the embodiment, a presentation renderer 6 translates the instructions of the declarative definition language 9, including any calculations 8, into instructions that a user interface tool 1 a uses, such as HTML for a web browser 1. The form can be displayed in a web browser 1, a mobile app 2, a desktop app 3, a plug-in installed into a third-party application 4 (thus adding the form capability to a third-party system), or to a printed page 5. It can be appreciated that the printed page 5 can be in any form of physical or digital printing, including printing in Adobe PDF format.

It should be appreciated that any communication medium 7 may be used to facilitate interactions between different components of the system 1b of FIG. 1C, including a processor 1c, electronic storage 1d, and image capturing device 1e connected to the user interface tool 1a. One or more components of the system 1b may communicate with each other through hard-wired communication, wireless communication, or both. For example, the one or more components of the system may communicate with each other through a network. For example, the processor 1c may wirelessly communicate with the electronic storage 1d. By way of non-limiting example, wireless communication may include one or more of radio communication, Bluetooth communication, Wi-Fi communication, cellular communication, infrared communication, or other wireless communication. Other types of communications are contemplated by the present disclosure and not excluded.

In some implementations, the processor 1c comprises a plurality of processing units. These processing units may be physically located within the same device, or may be a plurality of devices operating in coordination. The processor 1c may be configured to execute one or more components by software; hardware; firmware; some combination of software, hardware, and/or firmware; and/or other mechanisms for configuring processing capabilities.

Furthermore, it should be appreciated that although the various instructions are illustrated in FIG. 1C as being co-located within a single processing unit, it could also be implemented to include multiple processing units with one or more instructions which may be executed remotely from the other instructions.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, the processor(s) 1c may be programmed by one or more additional instructions that may perform some or all of the functionality attributed herein to one of the computer-readable instructions.

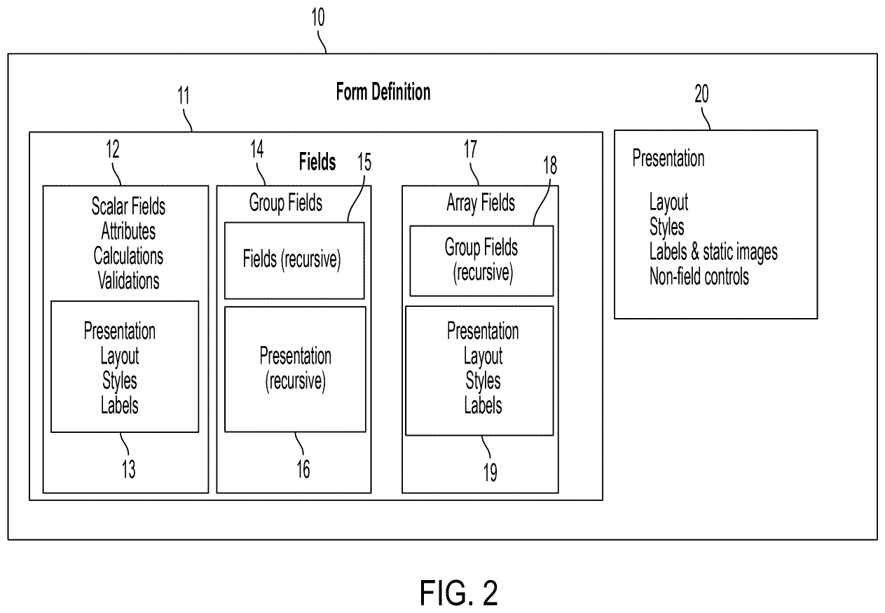

Referring to FIG. 2, there is shown a diagram of the declarative definition language to support defining a form according to an embodiment of the present invention.

The declarative definition language 9 defines a data structure for a form based on fields 11 and presentation 20 associated with the form. Such data structure allows data associated with the fields 11 and appearance of the form to the user to be handled separately, thereby enabling the form to be rendered to different screen sizes & capabilities, paper sizes, formats, etc., without requiring rules or code to be written.

In other embodiments, the fields 11 include scalar fields 12 (such as text, numbers, images, etc.), group fields 14, and/or array fields 18. The form is scalable, allowing new field types to be added as needed. The declarative definition language 9 is flexible to be used with a variety of data formats, including JSON and XML.

The scalar fields 12 refer to field types that contain one piece of information, such as text, a number, or date. These types will have a typical way of being presented to a user, but may also be presented in another manner depending on the needs of the form. For example, numbers may be presented with or without thousands separators (commas), long text may be truncated with an ellipsis to permit the user to press to see more of the long text, and dates can be shown in any number of formats.

The group fields 14 allow for a set of fields 11 (themselves scalar, array, or groups) to be treated together logically. For example, an address could be a group made up of text fields for the street address, city, state, and zip code. One enable calculation on the address group can control all of the fields within it. Furthermore, the group may be presented with shared attributes such as background color (in the example, this could be used to differentiate the shipping and billing addresses), to embed the group within a section that the user can open or close, possibly to save screen area, to group data into tabs that the use can switch between, or other ways of presenting the data.

The array fields 18 allow for repeating groups, such as line items on an invoice. The presentation for an array may include options such as layout for each item, horizontal vs vertical arrangements, or displaying data from the array in graphs or charts. The data in the array might also be filtered for presentation.

In some embodiments, the scalar fields 12 specifies attributes associated with data, initial values, calculations to be performed for a field (such as allowing a value for a field to be updated when a value for another field is changed), and validations that can be enforced (such as minimum values). The scalar fields 12 also contains presentation information 13 relating to a layout, styles, and/or labels for the scalar fields 12.

In some embodiments, the group fields 14 allow for indefinite nesting of data, and allow for additional presentation information 16 to be added. The group fields 14 repeats the data structure of the form as a whole, and its presentation block allows for the same flexibility as it does for the form.

In some embodiments, the array fields 18 is homogeneous or heterogeneous, and contains presentation information 19 for an array as a whole as well as for the group fields 14 contained within the array.

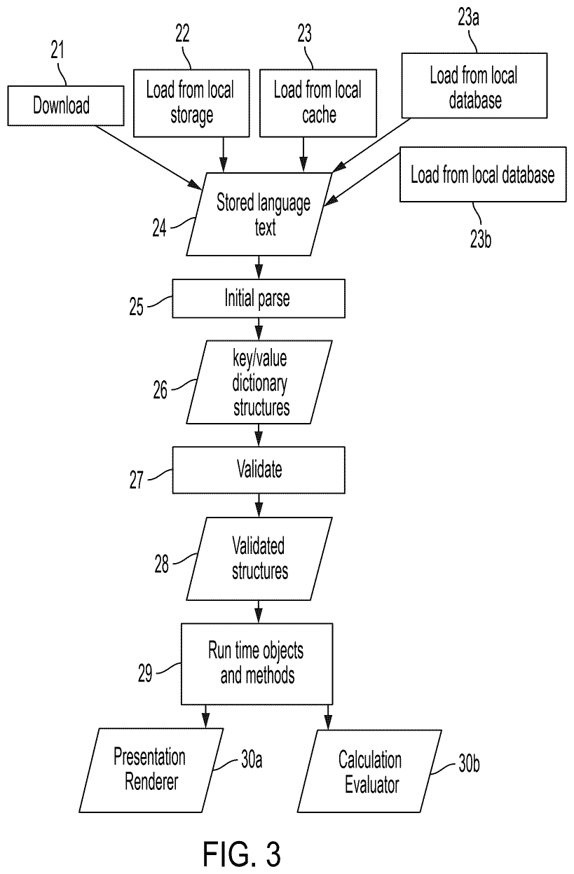

Referring to FIG. 3, there is shown a diagram of the loading process for the declarative definition language according to an embodiment of the present invention.

The declarative definition language 9 is downloaded 21 from a server, loaded from a local or networked storage 22, loaded from a local cache 23, loaded from a local database 23a, loaded from a remote database 23b, or loaded from any other storage system or architecture known in the art. In an exemplary embodiment of the present invention, JSON is used as an underlying text-based representation in the stored language text 24, but it can be appreciated that other formats could be used, such as YAML, XML, binary representation custom/proprietary formats, etc.

The stored language text 24 is initially parsed 25 from JSON (or other) into a basic keys-and-values nested dictionary structure 26. The keys-and-values nested dictionary structure 26 is then validated 27 against a schema to ensure that a JSON data structure matches an expected structure, and if so, results in validated structures 28. Once the JSON data structures are validated, run-time objects and methods 29 are created such that they can then be used directly by other components of the system, such as the presentation renderer 30 a and the calculation evaluator 30b.

The operations of the loading process presented herein are intended to be illustrative and, as such, should not be viewed as limiting. In some implementations, the loading process is accomplished with one or more additional operations not described, and/or without one or more of the operations discussed. In some implementations, two or more of the operations occur substantially simultaneously. The described operations may be accomplished using some or all of the system components described in detail above.

In some implementations, the loading process is implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices include one or more devices executing some or all of the operations of the loading process in response to instructions stored electronically on one or more electronic storage mediums. The one or more processing devices may include one or more devices configured through hardware, firmware, and/or software to be specifically designed for execution of one or more of the operations of the loading process.

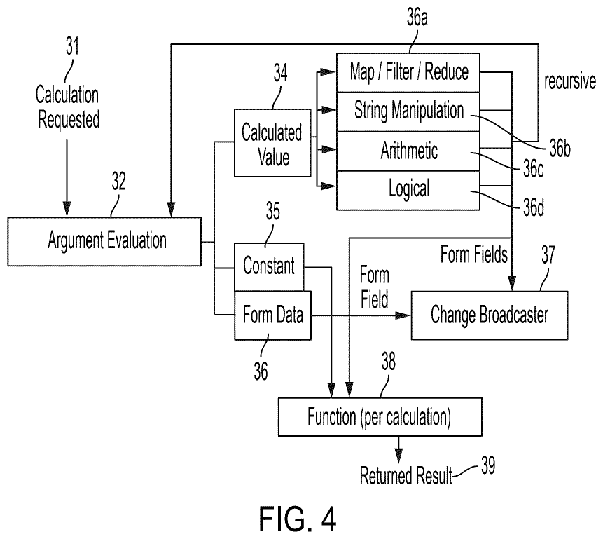

As seen in FIG. 4, a diagram of the calculation engine according to an embodiment of the present invention.

Even though the declarative definition language 9 is used, other embodiments of the present invention provide for a calculation 31 to be written. In such a case, a calculation evaluator's run-time evaluates an argument 32 against form data 36 and returns a result 39. The calculation 31 includes constants 35, retrieval of form data values 36, and calculations using map/filter/reduce 36 a for transformation of large data sets, string manipulation 36b, arithmetic 36c, and logical operations 36d. The calculation 31 is designed with the data form in mind and are under the same control as the rest of the system, allowing new functionality to be added easily.

In some embodiments, when evaluating the calculation 31, first arguments 32 must be evaluated. Types and meanings of the first arguments 32 are dependent on specifics of the calculation 31. In most cases, the first arguments 32 can themselves be additional calculations for the calculation 31. When the calculation 31 references the form data 36, a reference associated with the form data is collected and registered with a change broadcaster 37 along with information about an intent of the calculation 31. For example, if a user is allowed to enter a date range, then the user can enter a start date and be allowed to edit an end date or a number of days, with a change to the end date changing the number of days and vice versa. Such functionality allows users to conveniently and efficiently edit form fields.

In some embodiments, the change broadcaster 37 monitors the form data 36, so that when a value of a field is changed (via user input, calculation, or anything else), a caller associated with the calculation 31 that is affected will be notified that the value of the field may have changed.

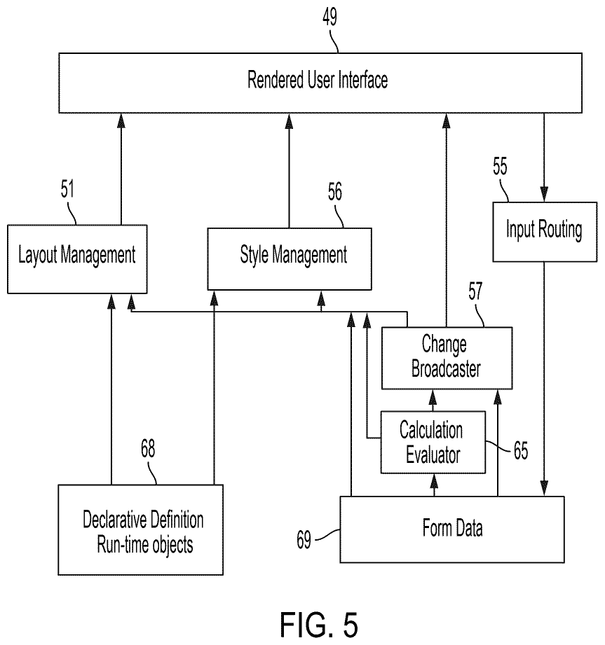

FIG. 5 shows a diagram of the presentation renderer according to an embodiment of the present invention.

The presentation renderer 6 combines the presentation information 20 provided by the declarative definition language 9 and the form data 69 to create the layout and styling instructions for the rendered user interface 49. According to one aspect of the invention, the declarative definitions include declarative definition run-time objects 68.

A layout management 51 processes the information to provide a placement and sizing of controls, including dynamic features such as tabs and collapsible areas, while the style management 56 concerns itself with an appearance of a form, such as fonts, colors, column and row sections, field height and width, margins, etc. The layout management 51 can also include an ability to show and hide controls dynamically, such as when a billing address is the same as a shipping address. It can also be appreciated that there are many other real-world scenarios where such dynamic hiding and showing can be accomplished.

In some embodiments, the form data 69 is directly entered by a user through the rendered user interface 49 or is retrieved by other means, such as through a camera, microphone, Bluetooth thermometer, etc. This form data 69 is then routed back to the form through an input routing 55.

In some embodiments, changes in the form recorded by the change broadcaster 57, either directly or indirectly because of calculation evaluations in an calculation evaluator 65, is broadcasted back to the layout management 51, a style management 56, and/or the rendered user interface 49 as needed so that the user always sees the current data. This also allows a single data field to be rendered in more than one fashion while automatically staying synchronized. For example, according to one aspect of the present invention, a “rating” field could be shown and changed as a numeric value, a slider, a set rating of stars, or any combination of these and other field types known in the art. The presentations of the field will show the same value, always, regardless of how the field is rendered.

The rendered user interface 49 is most commonly rendered into HTML for display in a browser or an embedded control that works with HTML, but it can be appreciated that it could be rendered in many different ways. In one embodiment, the rendered user interface 49 is rendered into Postscript for printing or saving in a PDF document. In another embodiment, the rendered user interface 49 is rendered into a series of commands for a native user interface, such as Cocoa Touch for iOS or WPF for Windows.

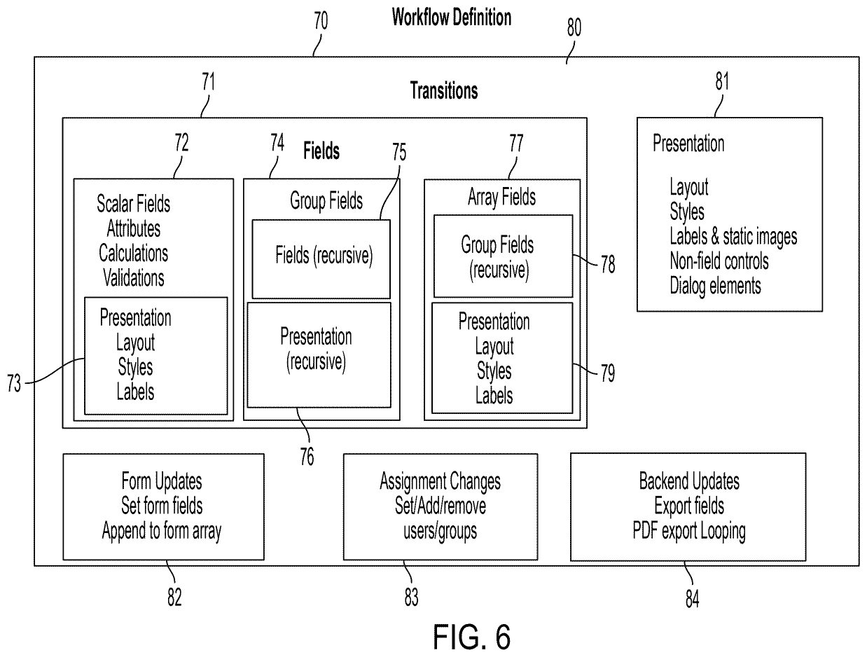

As shown in FIG. 6, there is a diagram of the declarative definition language to support defining a workflow according to an embodiment of the present invention.

The declarative definition language defines a workflow 70 as a collection of transitions 80. Each transition can comprise fields 71 and presentations 81, form updates 82, assignment changes 83, and backend updates 84.

In some embodiments, the fields 71 of the transitions 80 define the same way as a field in a form. Often, the fields 71 of the transitions 80 are initialized by copying values from fields of the form.

The presentations 81 associated with the transitions 80 are optional, and are defined the same way as a presentation associated with the form, with additions of dialog elements, prompts for the user, and text for “OK” and “Cancel” buttons. A transition without presentation does not need user interaction to complete.

In some embodiments, the form updates 82 map the fields 71 of the transitions 80 to the fields of the form, either copying values from the transitions 80 to the form, or appending a new group onto an array associated with the form. This allows the transitions 80 to modify values that the user is normally not permitted to change, which can be used to enforce data consistency.

In some embodiments, the assignment changes 83 either set the form's assignment to a collection of users or groups, or selectively adds and remove users and groups from the existing assignment. A calculation 31 may be used in this process.

In some embodiments, the transitions 80 trigger the backend updates 84 to the backend systems. The transition definition includes multiple updates. Each update specifies fields to be exported to the back end systems, exporting the form as a PDF or other rendering, and making multiple calls based on content array fields. In one aspect of the invention, these fields are filtered.

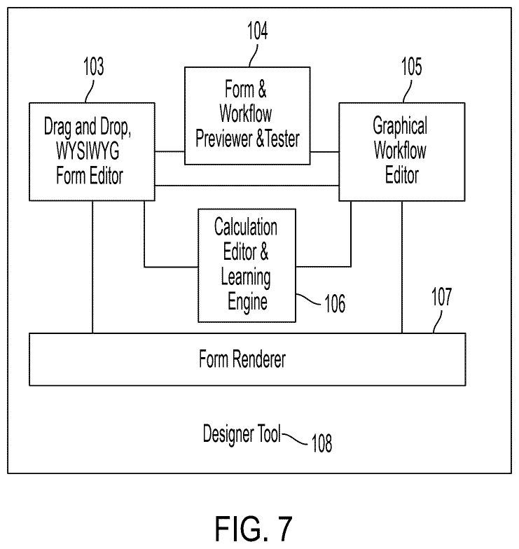

Referring to FIG. 7, there is shown a diagram of a designer tool 108 for designing a workflow according to an embodiment of the present invention.

The designer tool 108 is made to be easy for a person familiar with operations and processes of her business to create forms. The person designing a form does not need to know any underlying programming language.

In some embodiments, the designer tool provides a form editor 103. The form editor 103 presents a what-you-see-is-what-you-get view of the form. The user can add and remove fields, and change their attributes.

In some embodiments, the designer tool 108 provides a graphical workflow editor 105. The graphical workflow editor 105 presents workflows as either a flow chart or a “swim-lane” style process so that the workflows are easy to understand and change.

In some embodiments, the designer tool provides a previewer/tester 104. The previewer/tester 104 allows the user to see the form as it will appear on various screen sizes, to enter test data to ensure correct functionality, and to exercise the workflow.

In some embodiments, the designer tool provides a specialized calculation editor 106. The specialized calculation editor 106 assists the user when working with calculations. The specialized calculation editor 106 has a learning feature that recognizes common patterns of usage and suggests them. The learning feature uses machine learning to identify common patterns across all of the fields on all of the forms in the system and suggest the appropriate calculations or calculation arguments within the context of the field. The machine learning aspect allows it to evolve over time as more calculations are entered or updated and more forms are added to the system. Thus, the learning feature results in faster and more efficient operation of the specialized calculation editor 106 and enhances the form designer's experience.

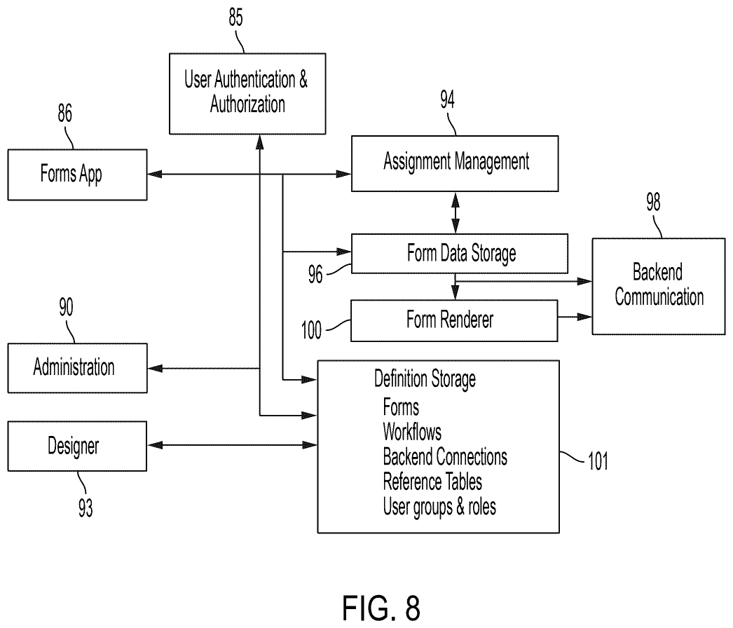

In FIG. 8, there is a diagram of a forms repository according to an embodiment of the present invention.

All of the data and definitions for use by the system are stored in a cloud-based or on-premises repository, which exposes a REST-ful API to allow access. The forms app 86 (including browser-based, mobile, desktop, or embedded third-party applications), administrative tools 90, and the forms designer tool 93 all use this API to access the repository. All calls must pass through user authentication and authorization processing 85.

The Assignment Management 94 controls which forms are assigned to which users, and therefore, which forms a user will see and are expected to work on. Forms may be assigned to zero, one, or more individual users, as well as to zero, one, or more user groups. Supervisor users may be given access to forms assigned to the workers that they supervise for viewing or for editing.

Definitions and definition-related items are stored together in a definition storage 101, with the expectation that they will be read frequently but written less often.

In some embodiments, the forms apps 86 reads and updates form data in the form data storage 96. Updates to the form data storage 96 can trigger calls to other backend systems through backend communications 98, such as through email or messaging systems, database systems, or other business systems. The forms renderer 100 runs entirely in the cloud, allowing the forms to be updated and even re-rendered.

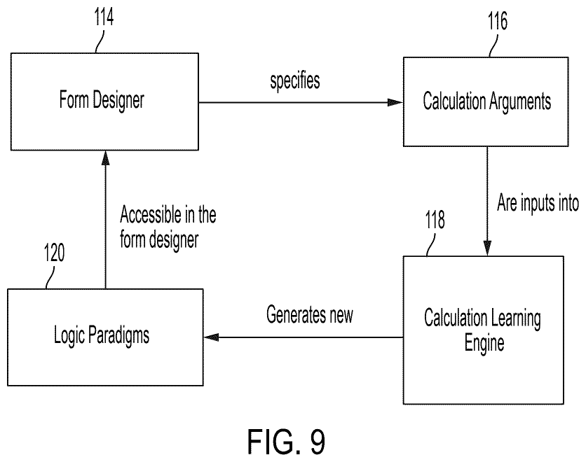

In FIG. 9, there is shown a diagram of a calculations learning engine according to an embodiment of the present invention.

The calculation learning engine 118 ingests calculation arguments 116 that have been defined on the forms by the form designer 114, examines them for patterns and potential extensions, and then generates logic paradigms 120 that can be used when creating calculation arguments in the form designer 114 on other forms and fields. The calculation learning engine 118 is constantly updating and releasing new logic paradigms 120 based on all of the form designers 114 using the form solution. Calculations 31 and calculation arguments 116, like many programming paradigms, are pattern-based. These patterns, while not obvious, are based on characteristics that include (but are not limited to) data type, relative position to other fields, relationship to other fields, field naming patterns, fields on other forms, forms within a given industry, etc. By continuously analyzing these characteristics using machine learning, the Calculation Learning Engine 118 improves over time and is able to suggest calculations and calculation arguments and can complete calculation and calculation arguments as a form designer begins to enter a calculation. The results are similar to the results of word processing tools that analyze grammar and context to offer options to finish sentences as you type. Thus, the Calculation Learning Engine 118 results in faster and more efficient operation and enhances the form designer's experience.

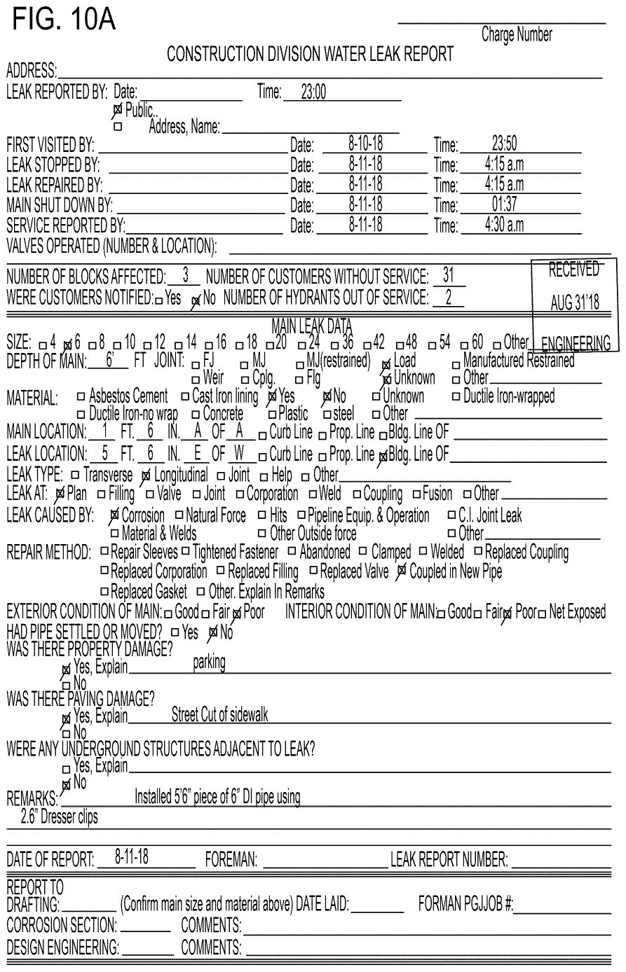

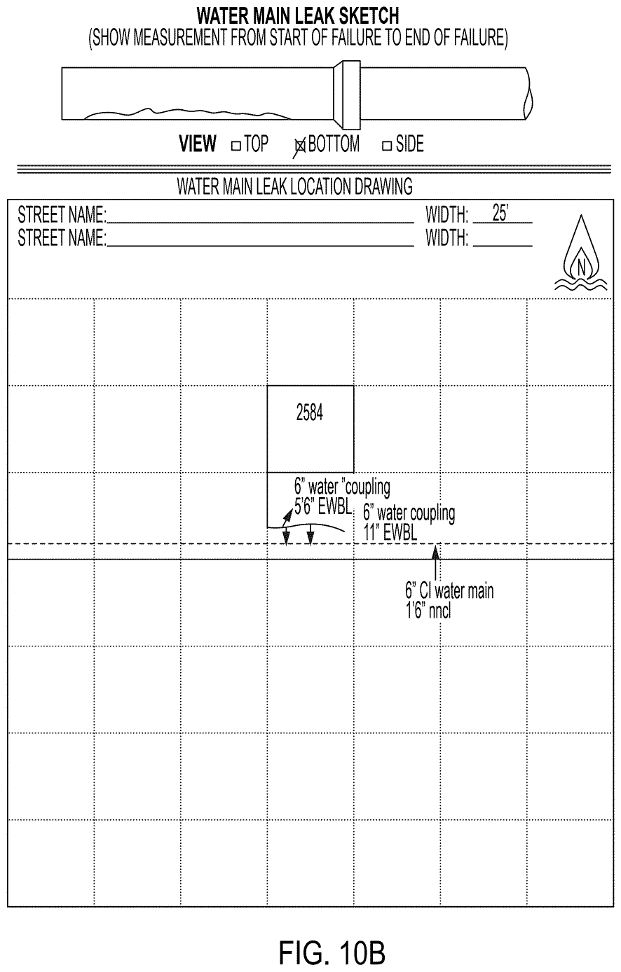

FIG. 10A shows a first page of an exemplary paper form that can be designed and generated into a digital format according to an embodiment of the present invention.

FIG. 10B shows a second page of an exemplary paper form that can be designed and generated into a digital format according to an embodiment of the present invention.

FIGS. 10A and 10B illustrate a typical paper form of the kind to be digitized and replaced by an exemplary embodiment of the present invention. As is routine in field force industries like infrastructure inspection, the paper form includes many different fields and many different types of fields for editing and input by the user (in this case, a water leak inspector). By way of example, the water leak report shown in FIGS. 10A and 10B includes different fields for the address of the leak, dates of inspection, checkboxes for leak characteristics, an area for additional user input and comment, and an area for sketching and drawing the leak, among others.

After editing by the user, paper forms in field force industries such as those shown in FIGS. 10A and 10B are manually delivered or routed through various stakeholders. This routing could take anywhere from several hours to several days or even weeks due to the necessity of manual processing. Moreover, changes to such forms cannot be deployed instantaneously across all users, resulting in the handling of outdated forms and further contributing to inefficacies in processing. Additionally, analysis or processing of the underlying data across a plurality of different paper forms can be burdensome, requiring one to retrieve and review every relevant form to collect the necessary data.

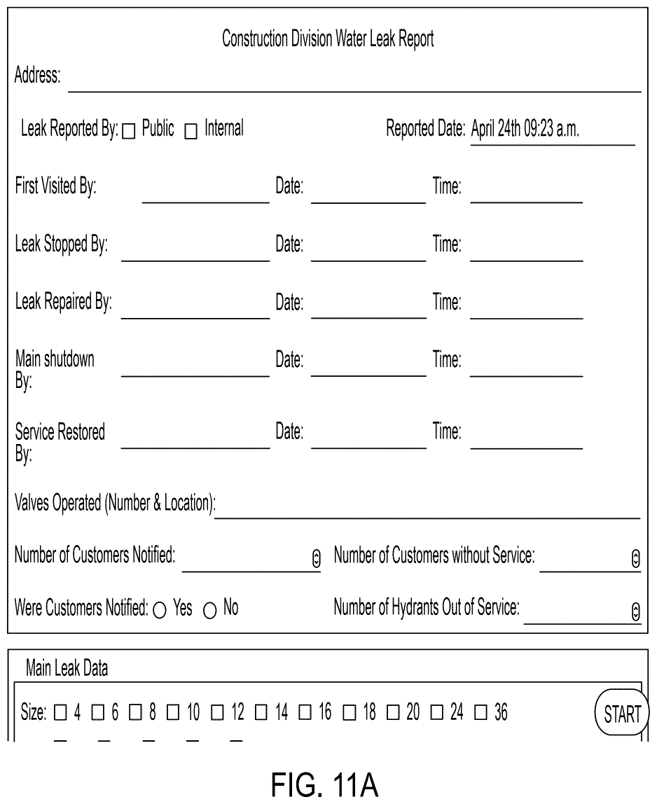

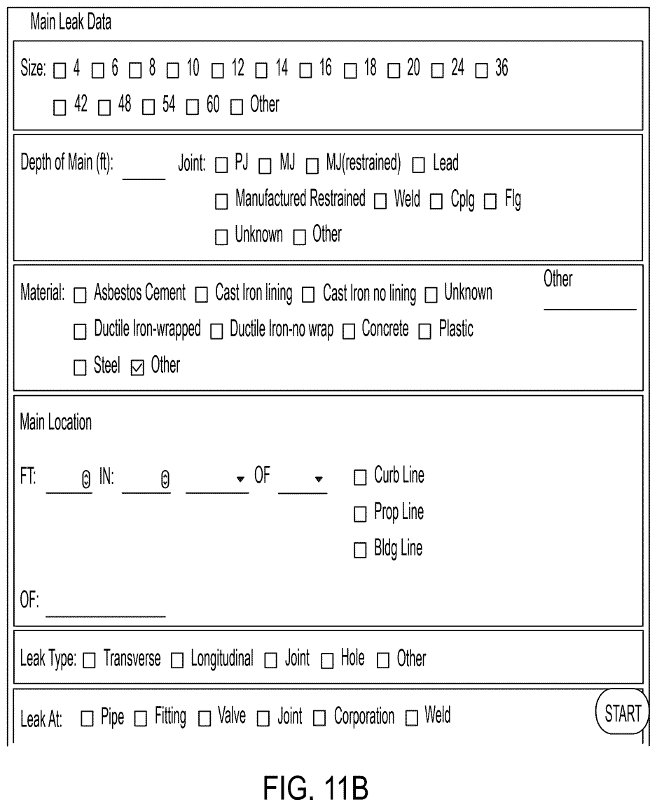

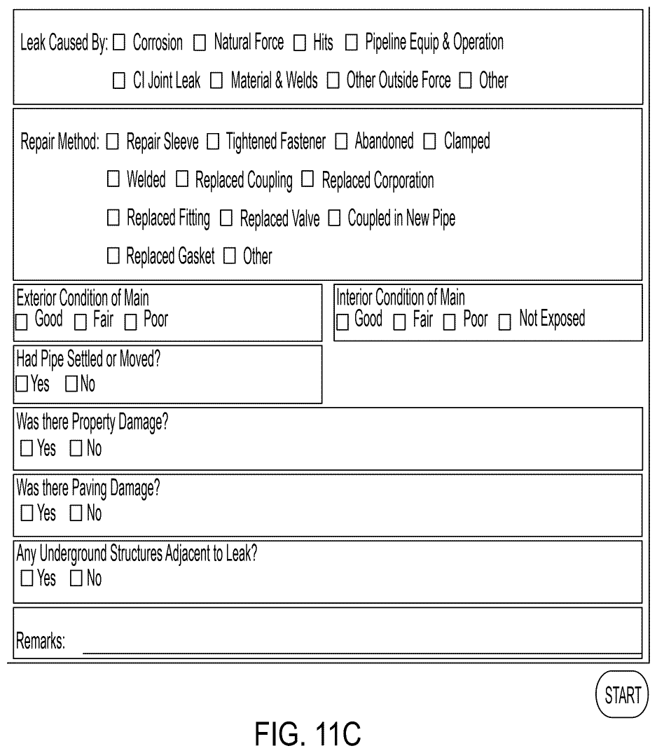

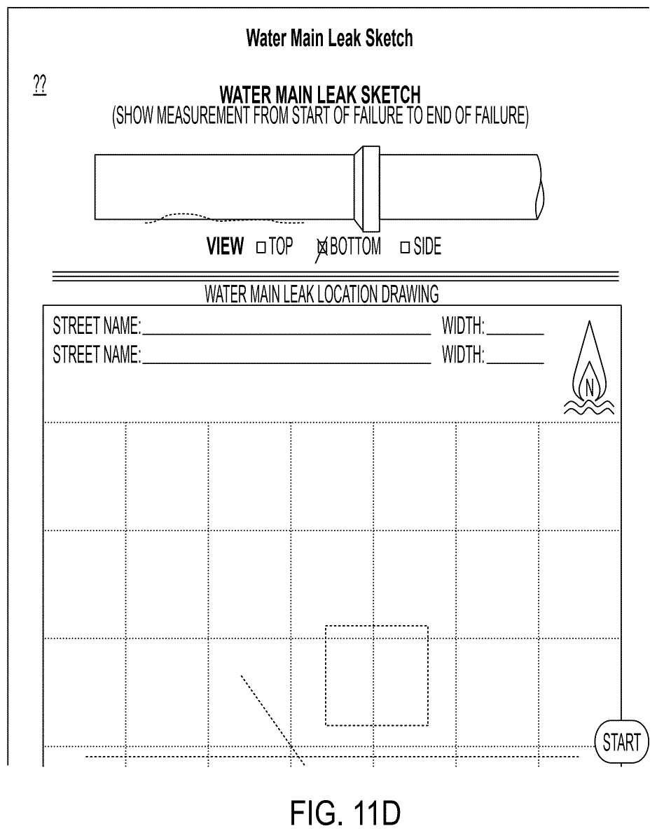

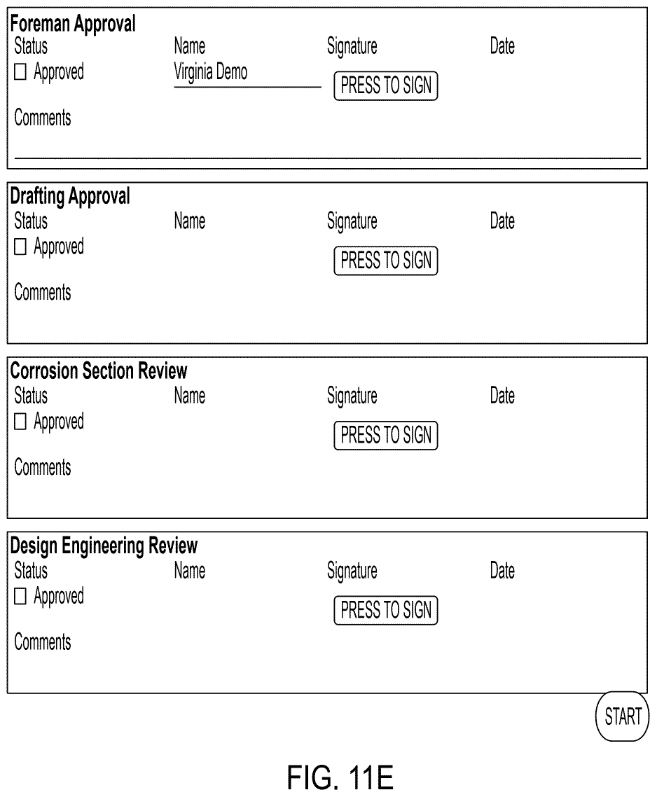

FIGS. 11A, 11B, 11C, 11D, and 11E illustrate different examples of digital forms generated from the paper form of FIGS. 10A and 10B using the system and process disclosed herein. It can be appreciated that the digital forms generated in FIGS. 11A-11E can be consistently displayed across a variety of different user interfaces, including web, mobile, and desktop applications. It can be further appreciated that the many different fields and the many different types of fields that would be addressed manually using the paper form of FIGS. 10A and 10B can be designed and generated using the system and method of the present invention, including the address of the leak, dates of inspection, checkboxes for leak characteristics, an area for additional user input and comment, and an area for sketching and drawing the leak, among others. Business users or form designers are able to easily generate such digital forms from the corresponding paper forms and do not need to be skilled at writing code. The use of such digital forms allows for rapid and efficient processing by the various stakeholders involved, and also allows for sophisticated analysis of the underlying data. For example, one could easily search for every water leak inspection report that occurred on a certain day or by size and material of the water main. Moreover, any updates to the form itself are instantly deployed to all users without the need for manual updating.

According to one embodiment of the present invention, a user begins designing a form by using an application, software, or other program installed on a computing device or server to operate a form designer tool. This user does not need to know any underlying programming language in order to operate this tool. The form designer tool features a form editor that presents the user with a WYSIWYG view of the form, allowing the user to easily add or remove fields, change their attributes, position, and orientation, as well as allowed input arguments. Machine learning processing will also suggest to the user appropriate calculations or calculation arguments as more calculations are entered or updated and more forms are added to the system. This processing allows these forms to be designed more efficiently and quickly. For example, a supervisor in a city's water department may wish to design a form for water leak inspections that would include the address of the leak, the date of inspection, checkboxes for leak characteristics, an area for additional user input and comment, and an area for sketching and drawing the leak. If there were other forms already in the system, the machine learning processing could suggest to the supervisor additional date or checkbox fields, for example, as the supervisor edits and designs the form. The user is also able to operate a graphical workflow editor that automates the form designing, management, and/or processes so that forms can be more quickly and efficiently designed and reviewed.

After a form is designed, either the form designer or additional users may input and edit data into that form as determined by the design of the form. For example, a water leak inspector may edit a field to input the address of a leak. It can be appreciated that this inspector would be able to input and edit these forms on any manner of mobile or stationary computing devices and that the forms would automatically adjust and scale for proper display on those devices. Thus, the inspector could edit the form in a convenient manner on the job site, at home, work, or any combination of various locations and at different times as necessary. At the conclusion of editing, the completed form would then be automatically routed to various stakeholders that would need to review the details of the inspection. For example, the form could be automatically routed to contractors to provide an estimate for repairs. After the completed form is stored, it would also allow a supervisor in a local water department to search all such reports on a specific street or city block to assess the need for more major repairs or replacement of water lines.

As an end user (e.g., a technician) enters information into the completed form (e.g., the form generated in FIG. 11A), form processing module 0f creates a separate data structure using declarative definition language based form definitions associated with the form and process workflow definitions associated with the completed form. The created data structure stores structured form data that includes form definitions and process workflow definitions associated with the form. As used herein, a form definition contains the presentation (i.e., what the form looks like), and associated logic, rules, and calculations that validate entered data and allows for fields within sections to be dynamically displayed. For example, form data may specify what additional fields of the form are provisioned and subsequently displayed to the end user based on input received from an end user. A process workflow definition contains process steps from form instance creation through its full lifecycle. Process workflow definitions can further specify affected form definitions. For example, based on responses received from an end user, process workflow definitions may specify only a subset of a workforce may complete an assigned task based on credentials required to complete the assigned task. In this manner, form processing module 0f can evaluate a calculation against the form data, return a result, and update backend systems to reflect the update to the form data. Form processing module 0f can also leverage process workflow definitions to capture what process step the process is currently in and record how long a given process step takes in the workflow. Each process step of the workflow of the form can validate the form to that point in the process, change the assignment from one user or group to another, update backend systems, display other forms and trigger other work processes.

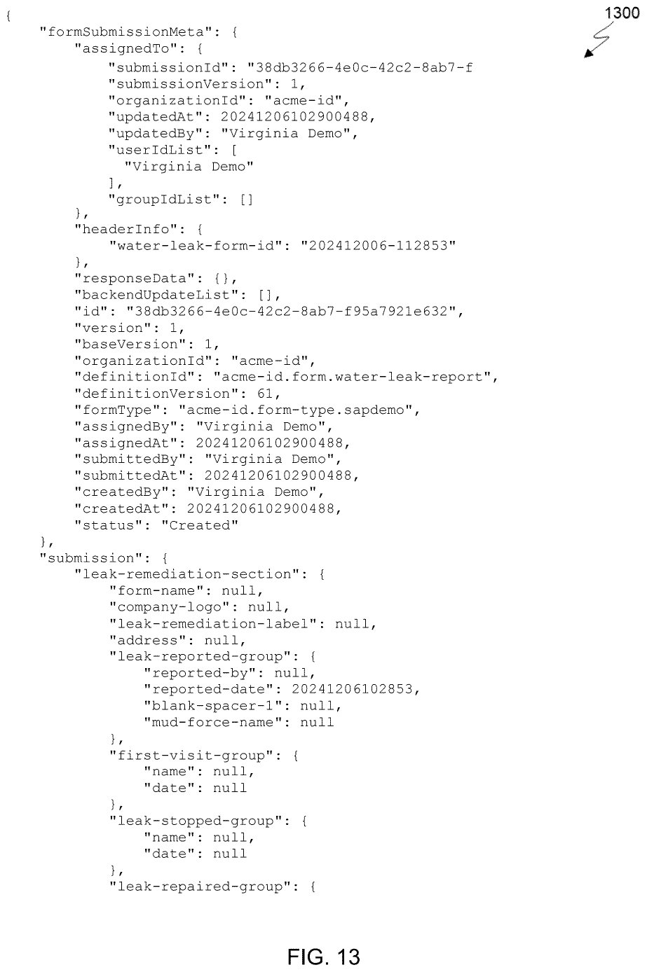

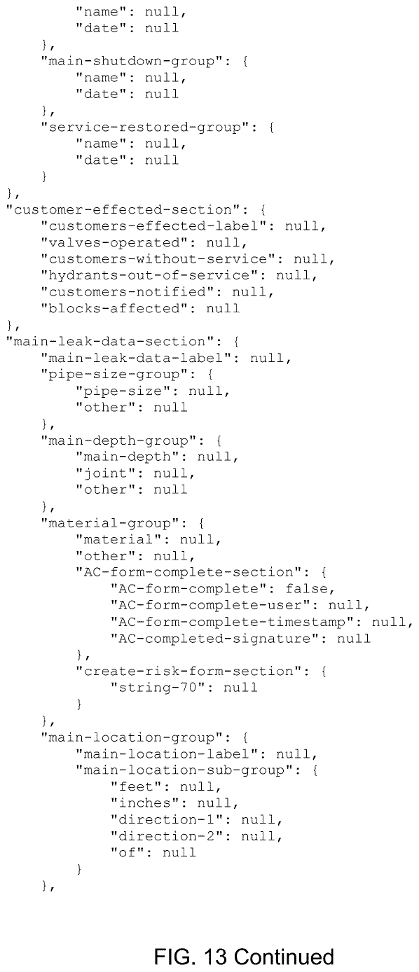

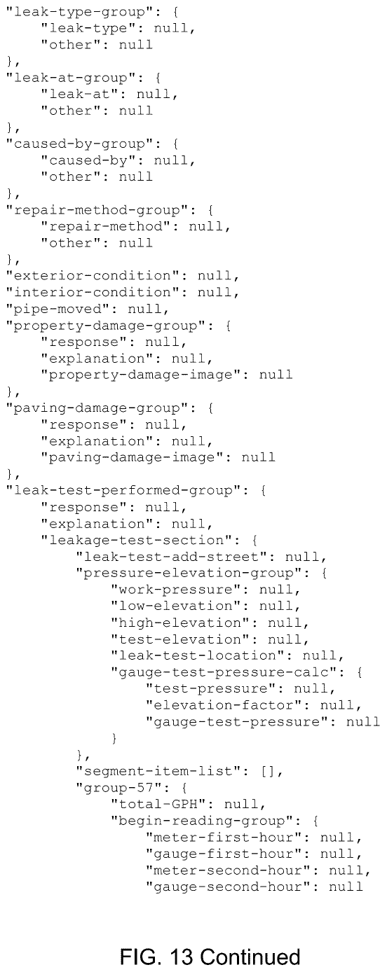

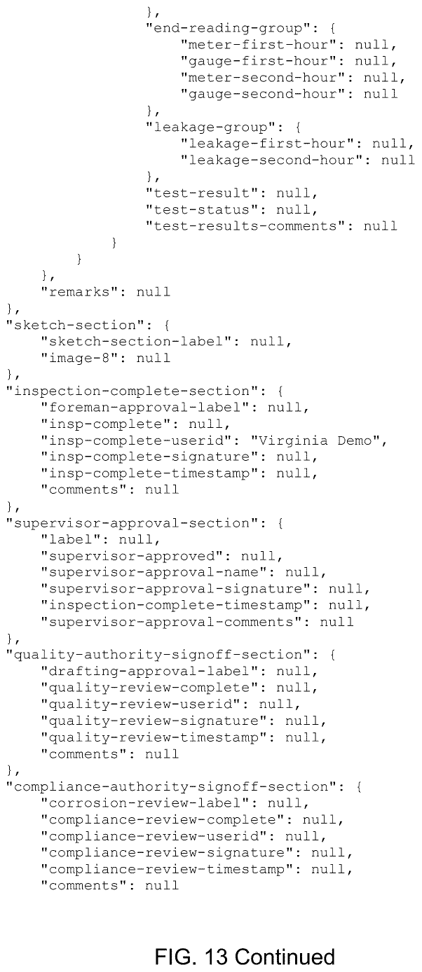

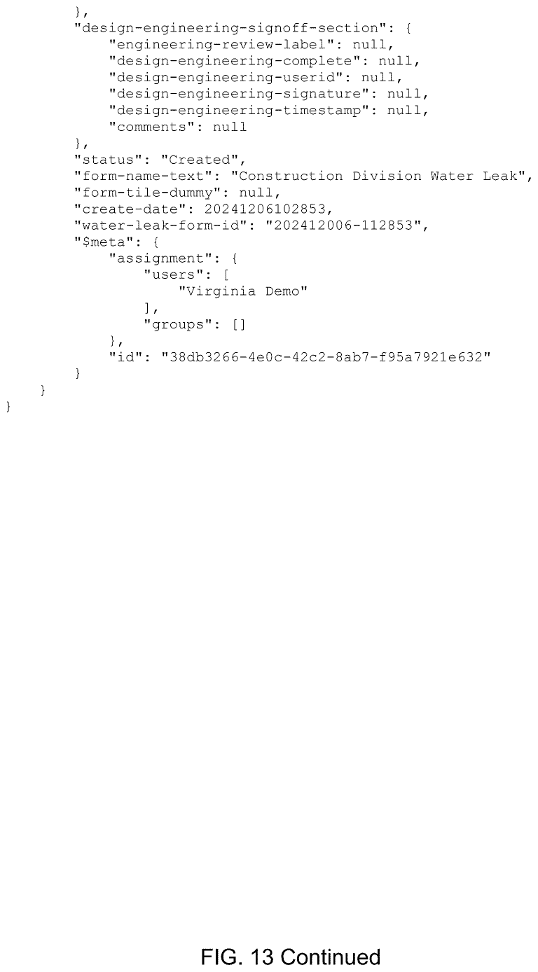

This created data structure, also referred to as a submission, represents a slice in time of the form data, associated form definitions, respective process workflow data (e.g., current data entered on the form, the current process step and status, its current assignment, which backend system updates were performed and whether they were successful) includes form data associated at point in time containing additional information that can be used to track version information of the created digital form along with unique identifiers that associated with the digital form (e.g., submission ID, submission version, organization ID, a time which the form was updated, a unique identifier for the user that performed the update, a user ID list, a group ID list, header information). Examples of unique identifiers include unique document properties such as submission ID, submission version, user ID list, header information, document ID, version, base version, organization ID, definition ID, definition version, form type, fields for “assignedby”, “assigneddate”, “submittedby” “submittedAt”, “createdby”, “created at” and status identifiers such as “started”) as shown and described in FIG. 13.

The created data structure also captures structured data (e.g., information entered into fields of the generated form) and converts unstructured data (e.g., handwritten notes, drawings, video, photo, etc.) to structured data received from the end user. In this manner, the created data structure provides additional form information that increases process observability by structuring typically unstructured and uncollected data including process information and organizing the collected data into searchable queries based on unique identifiers of the document (e.g., version, base version, associated definition identifiers, definition versions, etc.). By creating this data structure, embodiments of the present invention provide an efficient means to retrieve information thereby improving computer functions by reducing processing time and resources spent on file retrieval. In this embodiment, form processing module 0f creates the separate data structure (i.e., submission) during a give step (i.e., a specific action within a process indicating a completed action), such as the end user pressing “save”. Processing module 0f can configure the workflow to state what fields and data are required for that submission to be valid to allow the workflow to proceed (i.e., to allow a user to continue to the next section).

For each completed section (i.e., transition of a workflow section) of the form, state information associated with the section is saved as a separate data structure referred to as a submission along with the additional information associated with the digital form. In this embodiment, “state information” refers to a complete set of information that memorializes preceding events or user interactions within a section of a digital form. User interactions, refer to one or more actions taken by the user within a section of the digital form. For example, when filling out a water leak request form, user interactions such as the order in which text fields were completed, when a diagram was sketched, when a user uploaded an image of the job site, when a user sketched a diagram, when the user began work, took a break, and resumed worked can be memorialized as state information. In effect, the captured state information provides a snapshot of the digital form for a given time period. A “transition”, as used herein, refers to a section of a defined workflow of the form that, when completed, changes state information of the digital form. For example, for the forms generated to address a water leak completed state information can be saved as a submission.

The submission saves state information for at least a portion of the completed leak-remediation-section containing the following subsections such as leak-reported-group, first-visit-group, leak-stopped-group, leak-repaired-group, main-shutdown-group, and service-restored-group along with values for each of the respective subsections (e.g., values for leak-remediation-label, address, leak-reported group, reported by, etc.).

In this manner, the created data structure provides state and form information that can increase process observability by structuring typically unstructured and uncollected data and organizing the collected data in a manner that allows for searchable queries based on unique identifiers of the document (e.g., version, base version, associated definition identifiers, definition versions, etc.). The created data structure stores the user interactions as state information and can be leveraged as training data for a large process model. The user interactions (stored in the created data structure) can be fed into large process models. This is a technological improvement to process observability because user interactions such as the order in which things were completed off a form, when the user started and completed certain sections, were previously difficult or time consuming to collect or otherwise unavailable. Generative artificial intelligence algorithms trained on the created data structure would also be improved.

For mobile clients, form processing module 0f can periodically save an intermediate submission if the form has been inactive for a period of time (e.g., 2 minutes) to minimize data loss. In other words, in response to detecting an inactive period of time, form processing module 0f generating at least one intermediate submission (i.e., an intermediate data structure) to capture entered information. In those instances where one or more intermediate submissions are generated, form processing module 0f compiles intermediate submissions into a single submission in response to receiving confirmation that a process step is invoked or the end user triggers a manual command to save information inputted into that respective section.

In some embodiments, a user may, in the process of completing a form add one or more sections that affects one or more changes to a digital form. For example, based on a received input (e.g., answer to material used being asbestos cement), a second input field (to solicit additional information about the material used) may be displayed.

In this way, embodiments of the present invention can incorporate additional sections based on a user's provided response without having to make the additional section viewable if the additional section is not applicable to the user. State information can then be collected and saved as another submission to record values for the created transaction (e.g., risk-form-section subsections) and continue routing the user to the defined workflow of the digital form.

When all the form data has been entered (i.e., completed), embodiments of the present invention can compile the saved submissions containing state information for each respective section of the digital form along with the additional information as a JSON file. The compiled submissions can be persisted in storage according to user preferences to ensure data compliance with data retention and security policies. In this embodiment, form processing module 0f periodically exports the JSON file according to a schedule. In other embodiments, can automatically send the JSON file to a designated LPM. In yet other embodiments, a user can manually access this file, modify it, and/or send this file to a designated LPM. In this manner, by leveraging the state information from each submission, embodiments of the present invention can increase process observability by turning unstructured, informal process knowledge into structured data which can then be leveraged into generating actionable models and queries.

In some embodiments, form processing module 0f may obtain from one or more previously stored forms and respective data and definitions for use by the present system using a trained machine learning model that has been trained with a first training set comprising historical correspondences between forms. The training may be supervised, unsupervised, or a combination thereof, and may continue between operations for the lifetime of the system. The training may continue with use of the models to improve their accuracy over time. The parameters may include, for example and without limitation, submission data specific to an organization which may include data type, relative position to other fields, relationship to other fields, field naming patterns, fields on other forms, forms within a given industry, or any state specific information for a given section of the form that details a process. Time frames and weights may be assigned to each data point and calculated to determine a pattern of activity.

Thus, when a new section is selected for either a subsequent version of a digital form or to generate a new form, the parameters for the new section may be applied as a second training set to the trained model. In this way, the large process model may improve generated insights and, in certain embodiments, provide a recommendation using a collection of tools for process design, analysis, execution, and prediction that assists the user based on recognized common patterns of usage. The large process model can then be used as part of enhanced training data to train an artificial intelligence based system.

In instances where domain specific algorithms are employed to ensure regulatory compliance, embodiments of the present invention may provide the generated training datasets to a large process model to provide contextual information regarding the process undergone to yield the results of the process and subsequently use those large process models as part of enhanced training data for one or more artificial intelligence based systems. In this manner, embodiments of the present invention programmatically improve generated recommendations by increasing process observability via the generated training datasets that includes the structured state information which is organized into searchable queries based on unique identifiers of the document.

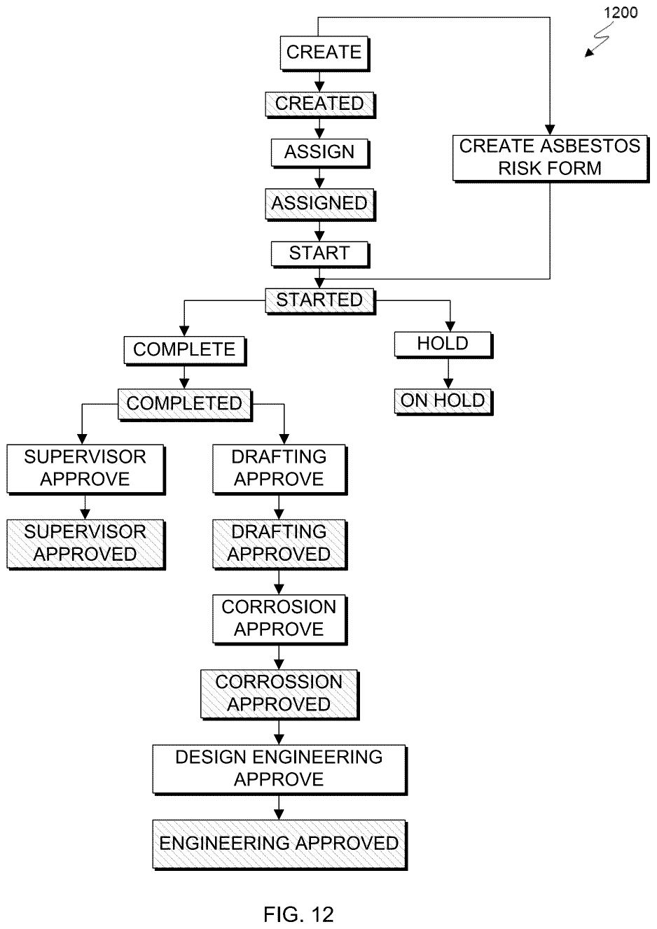

FIG. 12 represents an exemplary workflow of a created digital form according to an embodiment of the present invention.

Example process workflow 1200 is presented as a flow chart by graphical workflow editor 105 for a water leak. As each step in the workflow is completed (i.e., transition), form processing module 0f creates a corresponding submission for each completed block is created. This separate data structure contains detailed information regarding each completed section, how the section relates to other sections, approvals, timestamps and additional, detailed information that can be used to track version information of the created digital form along with unique identifiers that associated with the digital form.

The workflow for this created water leak form includes nine submissions (e.g., created, assigned, started, completed, on hold, supervisor approved, drafting approved, corrosion approved, engineering approved, etc.), represented by the functional blocks containing hash marks. For example, once the form is created and rendered, form processing module 0f creates a corresponding submission (e.g., submission ID, submission version, organization ID, a time which the form was updated, a unique identifier for the user that performed the update, a user ID list, a group ID list, header information).

In practice, more than nine submissions can be created based on user inputs. For example, based on user inputs, an additional form may be generated (e.g., an Asbestos Cement Job Safety Form was launched from the Water Leak Form). Submissions are also created each time the form is put on hold and restarted.

FIGS. 13, 14, and 15 represent an example submissions generated for a water leak form at various stages of a process workflow.

For example, FIG. 13 represents an example submission for a generated water leak form, in accordance with an embodiment of the present invention. Example submission 1300 represents a submission version (e.g., version 1) created when the water leak form was generated. Form processing module 0f creates this data structure to contain additional information that can be used to track version information of the created digital form along with unique identifiers that associated with the digital form. For example, the submission indicates that the status of the form is “created”, the form name is “Construction Division Water Leak”, the date which the form was created (i.e., “create-date”), the water leak form id, which users were assigned to this task and the unique identifier for this form. Initial submission parameters and values for “submissionID”, “submissionVersion”, “organization ID”, “updatedAt”, “updatedBy”, userIDList”, “headerinfo”, “id”, “version”, baseVersion”, “organzationID”, “definition ID”, “definitionVersion”, “formType”, “assigned By”, “assignedBy”, “submittedBy”, submittedAt”, “createdBy”, “createdAt” are also populated and saved. For example, the specific submission parameter for “reported date” is set to display the current date and timestamp. In example submission 1300, this submission parameter for “reported date” is set to and stored as “20241206102853” which reflects the current timestamp. In this manner, the created data structure allows users to track version information of the created digital form along with unique identifiers that associated with the digital form. In some embodiments, the created data structure can link to the specific version of the form associated with the submission. Certain other embodiments can provide a user interface that allows users to compare different versions of the form (e.g., form version 1 as compared to form version 2). The created data structure can also link to the specific definition (e.g., definition IDs and versions). In this way, users can access definitions (e.g., form and process workflow definitions) associated with the form. In some embodiments, form processing module 0f allows users to make modifications to definitions to create updated versions.

The other fields for subsequent sections such as leak remediation, customer effected, main leak data section, sketch section, inspection complete section, supervisor approval section, quality authority signoff section, compliance authority signoff section, and design engineering signoff section and corresponding subsections are left blank as they have not been populated with values from the end user.

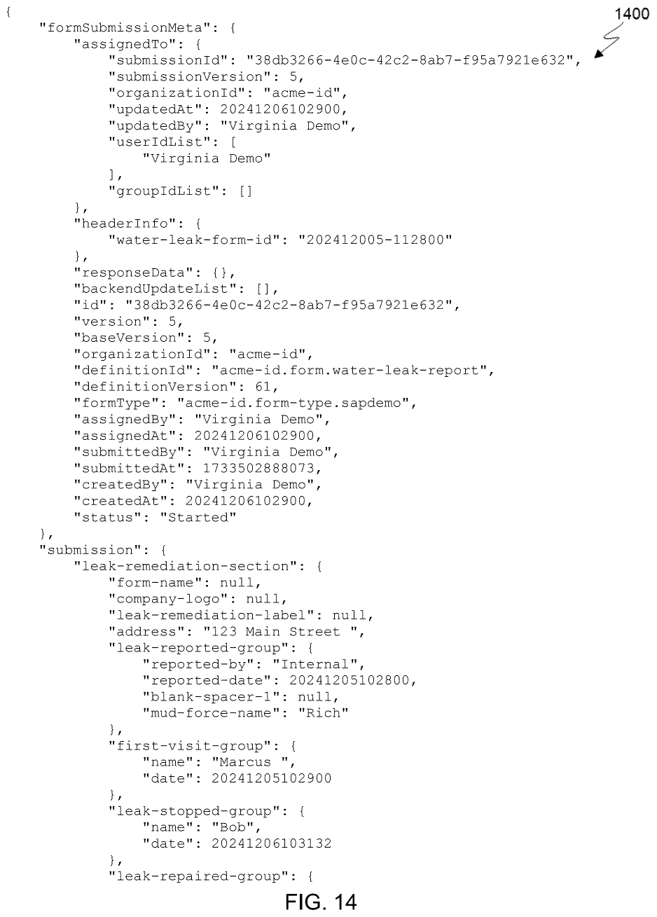

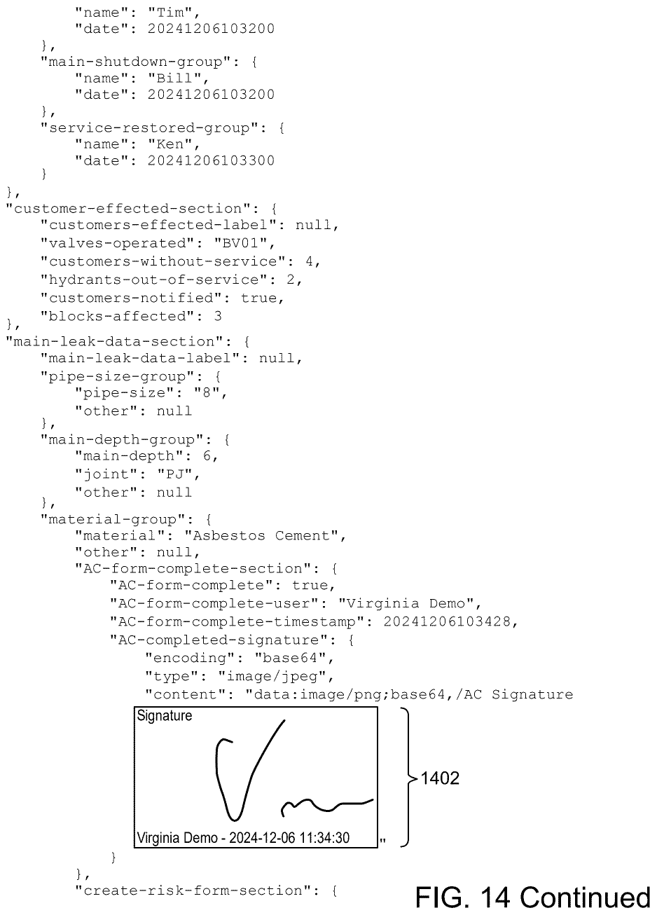

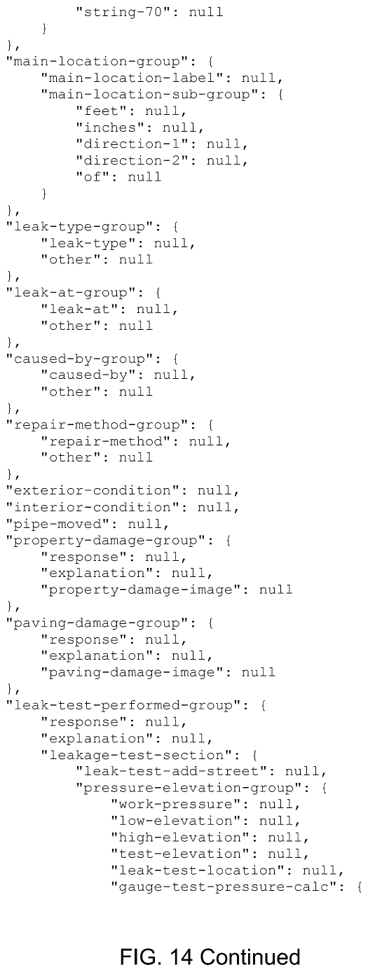

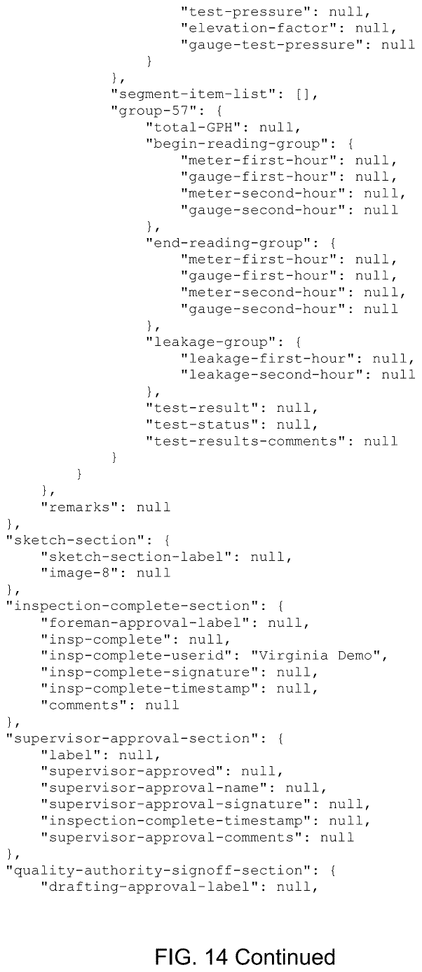

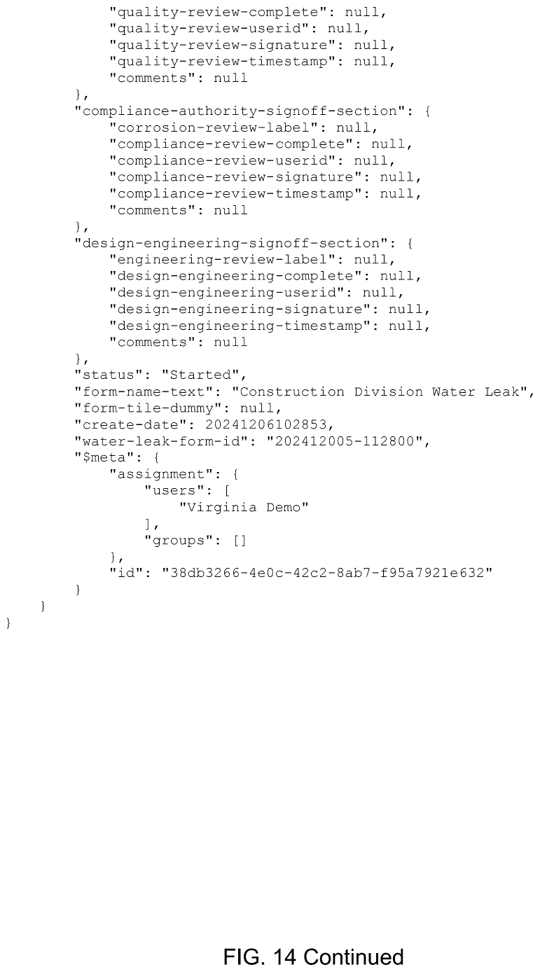

FIG. 14 represents an example submission for a generated water leak form in progress, in accordance with an embodiment of the present invention.

Example submission 1400 represents a submission version generated for a form that is in progress. Values “submissionID”, “submissionVersion” have been updated to “5” to indicate that this is the fifth submission for this form along with corresponding time stamps. Sections for leak remediation have been saved and additional information is captured such as the address for the water leak, who reported the water leak, the date the water leak was reported, who first visited (e.g., first visit group), who stopped the leak (e.g., leak stopped group), who repaired the leak (e.g., leak repaired group), who shut down the water flow (e.g., main shut down group), customers that were effected, which valves were operated, how many customers were without service, how many hydrants were out of services, whether customers were notified, and how many block were affected. The submission also details values for the size of the pipe that was affected, the depth of the pipe and what type of joint the pipe was.

Submission 1400 also includes a created section that affects one or more changes to a digital form. For example, based on a received input (e.g., answer to material used being asbestos cement), a second input field (to solicit additional information about the material used) such as the Asbestos Cement Job Safety Form was launched and according to form definitions routed the created section (i.e., sent the created section and form) to a group of users authorized to complete and approve the repair. Submission 1400 shows this form was completed as indicated by the complete status designation that identified which user completed the form, a timestamp of when the form was completed, and a signature of a person (e.g., signature block 1402) designated as having authority to complete this section.

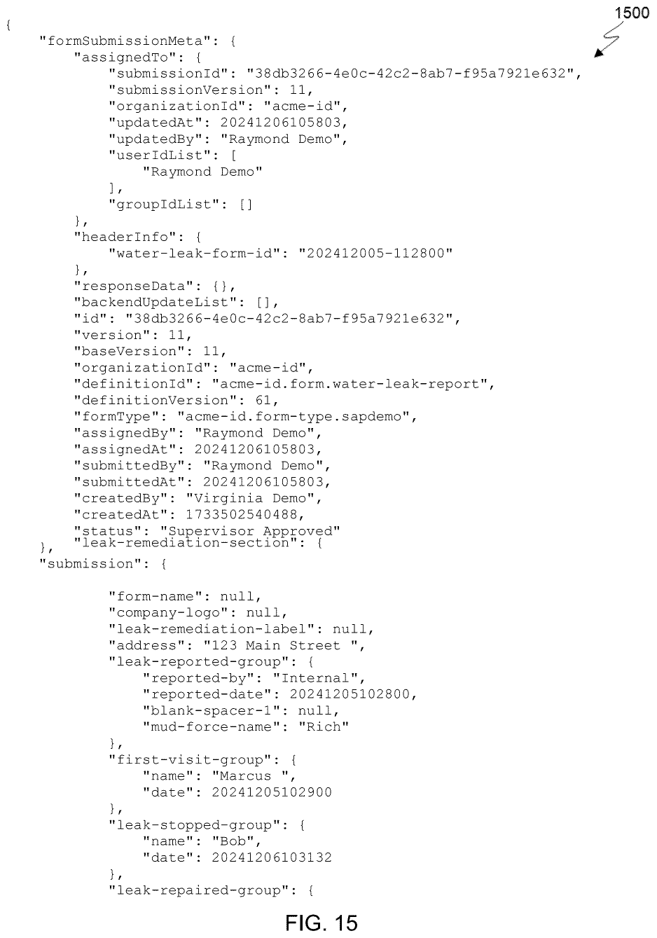

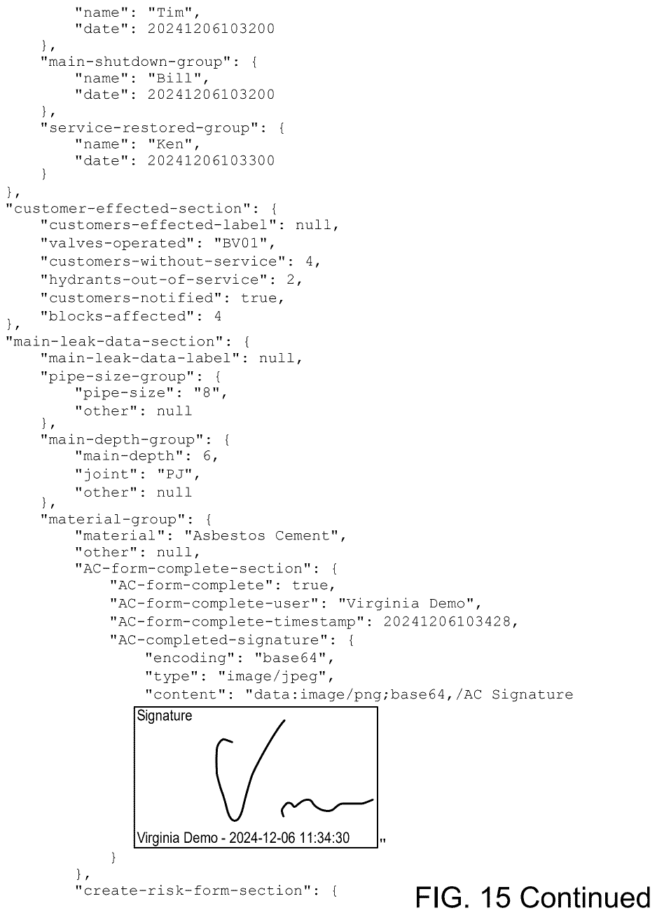

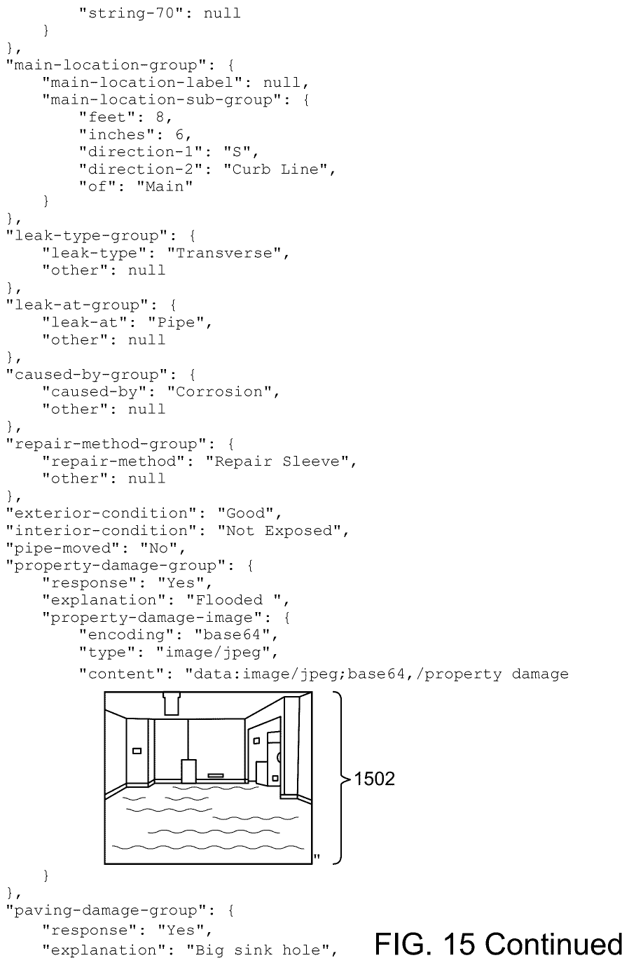

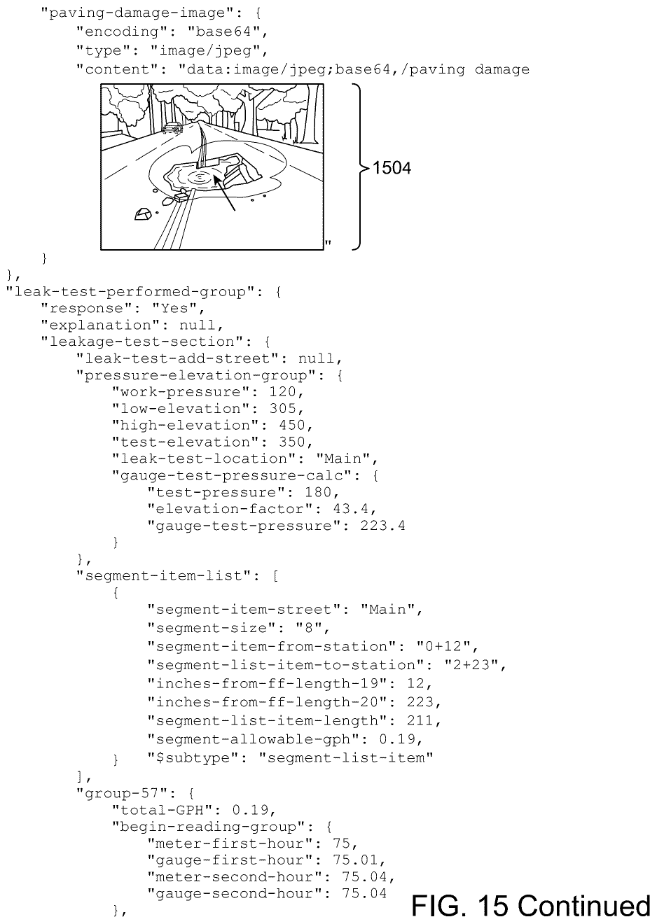

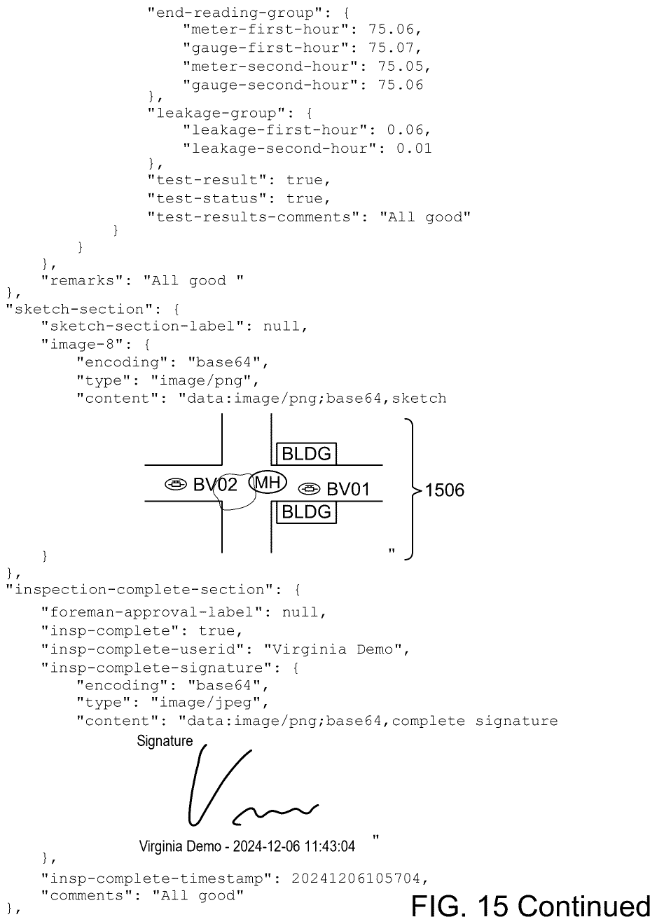

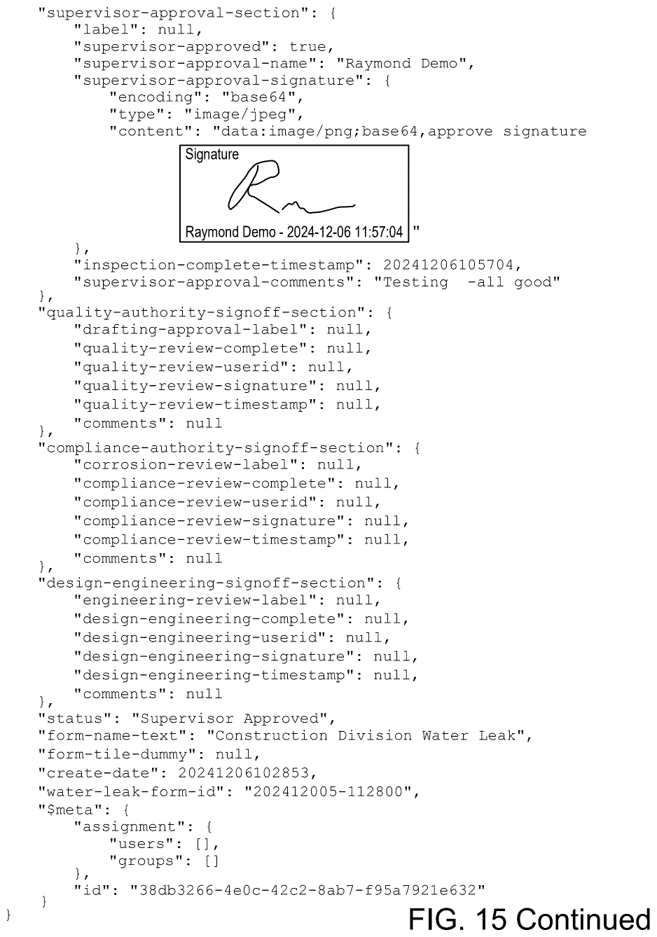

FIG. 15 represents an example submission for a completed water leak form, in accordance with an embodiment of the present invention.

In this example, submission 1500 has be routed to a supervisor for review and approval an action documented in a previous submission (not shown). In this example, submission 1500 represents a completed submission as indicated by the “supervisor approved” status designation. Submission 1500 includes compiled information of previous submissions appended to most recent completed section of the form. Specifically, submission 1500 illustrates the ability to capture non structured data and organize it in a structured manner. For example, submission 1500 includes encoded images (e.g., images 1502 and 1504) received from the user as well as a sketch section (e.g., sketch 1506) and associated context information for the respective images and/or sketches.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the claims.

What is claimed is:

1. A computer-implemented method for using a declarative definition language to generate training data, the method comprising:
rendering, by one or more processors, a form that includes one or more sections defined by a declarative definition language; and
in response to receiving input for a completed section of the one or more sections of the rendered form, generating a data structure that memorializes user interactions within the completed section of the rendered form.

2. The computer-implemented method of claim 1, further comprising:
providing, by one or more processors, the generated data structure as training data for a large process model.

3. The computer-implemented method of claim 1, wherein the data structure that memorializes user interactions within a section of the rendered form comprises state information that documents each section of the form.

4. The computer-implemented method of claim 3, wherein the data structure further comprises additional information for tracking versions of the rendered form along with unique identifiers that associated with the digital form.

5. The computer-implemented method of claim 4, wherein the data structure further comprises a configuration details for the form that specify which of the one or more sections and data are required for a valid submission of the completed section.

6. The computer-implemented method of claim 5, further comprising:
providing, by one or more processors, the data structure as training data for a large process model.

7. The computer-implemented method of claim 6, further comprising:
training an artificial intelligence based system on the large process model.

8. The computer-implemented method of claim 1, further comprising:
in response to detecting an inactive period of time, generating, by one or more processors, at least one intermediate data structure that captures entered information.

9. The computer-implemented method of claim 8, further comprising:
responsive to receiving confirmation that a process step of the form is invoked, compiling, by one or more processors, one or more intermediate data structures into a single data structure.

10. The computer-implemented method of claim 1, wherein generating a data structure that memorializes user interactions within the completed section of the rendered form comprises:
in response to receiving input for a section of the rendered form, evaluating, by one or more processors, a calculation against the form data and returning a result; and
in response to receiving an indication of an completed action, generating, by one or more processors, a data structure that stores a result of the calculation and the form data.

11. A computer program product for using a declarative definition language to generate training data, the computer program product comprising:
one or more computer readable storage media and program instructions stored on the one or more computer readable storage media, the program instructions comprising:
program instructions to render a form that includes one or more sections defined by a declarative definition language; and
in response to receiving input for a completed section of the one or more sections of the rendered form, program instructions to generate a data structure that memorializes user interactions within the completed section of the rendered form.

12. The computer program product of claim 11, wherein the program instructions stored on the one or more computer readable storage media further comprise:
program instructions to provide the generated data structure as training data for a large process model.

13. The computer program product of claim 11, wherein the data structure that memorializes user interactions within a section of the rendered form comprises state information that documents each section of the form.

14. The computer program product of claim 13, wherein the data structure further comprises additional information for tracking versions of the rendered form along with unique identifiers that associated with the digital form.

15. The computer program product of claim 14, wherein the data structure further comprises a configuration details for the form that specify which of the one or more sections and data are required for a valid submission of the completed section.

16. The computer program product of claim 11, wherein the program instructions stored on the one or more computer readable storage media further comprise:
in response to detecting an inactive period of time, program instructions to generate at least one intermediate data structure that captures entered information.

17. The computer program product of claim 16, wherein the program instructions stored on the one or more computer readable storage media further comprise:
responsive to receiving confirmation that a process step of the form is invoked, program instructions to compile one or more intermediate data structures into a single data structure.

18. The computer program product of claim 11, wherein the program instructions to generate a data structure that memorializes user interactions within the completed section of the rendered form comprise:
in response to receiving input for a section of the rendered form, program instructions to evaluate a calculation against the form data and returning a result; and
in response to receiving an indication of an completed action, program instructions to generate a data structure that stores a result of the calculation and the form data.

19. A computer system for using a declarative definition language to generate training data, the computer system comprising:
one or more computer processors;
one or more computer readable storage media;
program instructions stored on the one or more computer readable storage media for execution by at least one of the one or more computer processors, the program instructions comprising:
program instructions to render a form that includes one or more sections defined by a declarative definition language; and
in response to receiving input for a completed section of the one or more sections of the rendered form, program instructions to generate a data structure that memorializes user interactions within the completed section of the rendered form.

20. The computer system of claim 19, wherein the program instructions stored on the one or more computer readable storage media further comprise:
program instructions to provide the generated data structure as training data for a large process model.
